(19) United States
(12) Patent Application Publication
(10) Pub. No.: US 2009/0189995 A1
(43) Pub. Date: Jul. 30, 2009

(54) IMAGE RECORDING DEVICE, IMAGE REPRODUCING DEVICE, RECORDING MEDIUM, IMAGE RECORDING METHOD, AND PROGRAM THEREOF

(76) Inventors: Hiroaki SHIMAZAKI, Osaka (JP); Kenjiro TSUDA, Osaka (JP); Tatsuro JURI, Osaka (JP); Katsuo SAIGO, Hyogo (JP); Takashi MASUNO, Osaka (JP); Yuki KOBAYASHI, Osaka (JP); Takuma CHIBA, Osaka (JP); Yukinaga SEKI, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/358,442

(22) Filed: Jan. 23, 2009

(30) Foreign Application Priority Data
Jan. 24, 2008 (JP) 2008-014193

(51) Int. Cl. H04N 5/225

(52) U.S. Cl. 348/222.1; 348/E05.024

(57) ABSTRACT

An image recording/reproducing device of this invention includes the following units. An image signal processing unit generates second captured image signals according to a second method. A first compression unit generates first compressed image data by compressing first image information which is in the second captured image signals and equivalent to the first captured image. A second compression unit generates second compressed image data by compressing second image information which is in the second captured image signals except at least a part of the first image information. A recording unit creates first and second folders, and records the first compressed image data and a first playlist in association with the first folder and the second compressed image data in association with the second folder, so that parts of the first and second compressed image data captured during a same first time unit are recorded in association with each other.

### BACKGROUND OF THE INVENTION

(1) Field of the Invention

The present invention relates to an image recording device, an image reproducing device, a recording medium, an image recording method, and a program, and more particularly to an image recording device that records high-speed captured image or high-resolution image to a removable recording medium, the recording medium in which the high-speed captured image or the high-resolution image are recorded by the image recording device, and an image reproducing device that reproduces the high-speed captured image or the high-resolution image recorded in the recording medium.

(2) Description of the Related Art

There are known image recording devices, such as recordable DVD camcorders, that generate high-speed captured image having a frame rate higher than 30 frames per second (fps). Slow playback of the high-speed captured image captured at such a high frame rate enables high-accuracy analysis. Therefore, the image recording devices generating high-speed captured image are used in the fields of research and development.

An example of the conventional image recording devices generating high-speed captured image is disclosed in, for example, Patent Reference of Japanese Patent No. 2718409 that changes a size of each of frames in high-speed captured image to a smaller screen size, then multiplexes a frame to other frame(s) as being divided on a screen, and records the multiplexed data as normal image.

However, the conventional image recording device disclosed in Japanese Patent No. 2718409 has a problem that image quality of each frame is deteriorated because each frame is size-reduced before being recorded. In addition, when the resulting image is reproduced by image reproducing devices not supporting reproduction of high-speed reproduction image, the resulting image is displayed as being divided on a screen. That is, the conventional image recording device disclosed in Japanese Patent No. 2718409 has a problem of failing to ensure compatibility with image reproducing devices having conventional standards which do not support reproduction of high-speed reproduction image.

In the meanwhile, another image recording device is disclosed in, for example, Patent Reference of Japanese Unexamined Patent Application Publication No. 2007-104584 that records, from among frames in high-speed captured image having a frame rate higher than 30 fps, frames equivalent to image having a frame rate of 30 fps to a removable memory, and the remaining frames to a different memory.

This image recording device disclosed in Japanese Unexamined Patent Application Publication No. 2007-104584 does not perform a size reduction of each frame and the like, and therefore prevents the image quality deterioration. Moreover, the image recording device of Japanese Unexamined Patent Application Publication No. 2007-104584 can ensure compatibility with image reproducing devices having conventional standards which do not support reproduction of high-speed reproduction image, by storing frames equivalent to image having a frame rate of 30 fps in high-speed captured image to a memory and other frames to a different memory and then using only the frames equivalent to image having a frame rate of 30 fps.

However, since the frames equivalent to image having a frame rate of 30 fps and the other frames are stored separately in respective different memories, this conventional image recording device of Japanese Unexamined Patent Application Publication No. 2007-104584 has a difficulty in managing these frames as high-speed captured image.

Especially when a playlist is generated to specify a reproduction procedure for reproducing recoded image and then high-speed captured image is reproduced by the procedure based on the playlist, it is difficult to perform playlist editing since there are (i) a playlist regarding the frames equivalent to image having a frame rate 30 fps and (ii) a playlist regarding the other frames, which are stored separately in respective different memories.

There is another problem that image reproducing devices in conformity to conventional standards that do not support reproduction of high-speed captured image cannot edit playlists regarding high-speed captured image generated by conventional image recording devices.

More specifically, when an image reproducing device having a conventional standard perform playlist editing, the device edits only the playlist regarding frames equivalent to image having a frame rate 30 fps, and does not edit the playlist regarding the other frames. Thereby, when image reproducing devices having conventional standards perform playlist editing, consistency between (i) the playlist regarding frames equivalent to image having a frame rate 30 fps and (ii) the playlist regarding the other frames is lost.

As explained above, the conventional image recording devices have a problem that image reproducing devices having conventional standards that do not support reproduction of high-accuracy image cannot perform playlist editing for high-accuracy image, such as high-speed captured image, which is generated by conventional image recording devices to have a accuracy higher than conventional compatible image.

### SUMMARY OF THE INVENTION

The present invention addresses the above-described problems. It is an object of the present invention to provide: an image recording device capable of generating and recording high-accuracy image for which image reproducing devices having conventional standards can edit playlists; a recording medium on which the high-accuracy image for which image reproducing devices having conventional standards can edit playlists is recorded; and an image reproducing device that reproduces the high-accuracy image recorded on the recording medium.

More specifically, it is an object of the present invention to provide: an image recording device capable of generating and recording high-speed captured image for which image reproducing devices having conventional standards can edit playlists; a recording medium on which the high-speed captured image for which image reproducing devices having conventional standards can edit playlists is recorded; and an image reproducing device that reproduces the high-speed captured image recorded on the recording medium.

In accordance with an aspect of the present invention for achieving the objects, there is provided an image recording device that captures a second captured image and records the second captured image to a recording medium, the second captured image being captured according to a second method to have a accuracy higher than an accuracy of a first captured image captured according to a first method, and the recording medium being initialized to have a file system and being removable from the image recording device, the image recording device including: an image signal processing unit configured to generate signals of the second captured image according to the second method from electrical signals converted from incident light signals by an imaging element; a first compression unit configured to generate first compressed image data by compressing first image information that is image information included in the signals of the second captured image and that is equivalent to the first captured image; a second compression unit configured to generate second compressed image data by compressing second image information that is image information included in the signals of the second captured image except at least a part of the image information included in the first image information; and a recording unit configured to record the first compressed image data and the second compressed image data to the recording medium, wherein the recording unit is configured to (i) create a first folder and a second folder in the file system, (ii-1) record the first compressed image data and a first playlist in association with the first folder, and (ii-2) record the second compressed image data in association with the second folder, the first playlist specifying a procedure for reproducing the first compressed image data, wherein the recording unit is further configured to record the first compressed image data and the second compressed image data to the recording medium, so that a part of the first compressed image data and a part of the second compressed image data are recorded in association with each other, the part of the first compressed image data and the part of the second compressed image data being generated from a part of the second captured image which is captured during a same time period of a first time unit, and during one unit of the first time unit, (i) one frame according to the first method and (ii) at least one frame according to the second method are included in the part of the second captured image.

With the above structure, the image data according to the first method that is a conventional standard is recorded in the first folder, and a part of the image data according to the second method is recorded in the second folder. Thereby, when an image reproducing device having a conventional standard that does not support reproduction of the image captured according to the second method reproduces a recording medium on which the image captured according to the second method is recorded by the image recording device of the present invention, the image reproducing device having the conventional standard can reproduce the image captured according to the first method by reproducing the image data stored in the first folder. As a result, the image recording device according to the present invention can ensure compatibility with the image reproducing device having the conventional standard.

Furthermore, when an image reproducing device that supports reproduction of image captured according to the second method reproduces a recording medium on which the image captured according to the second method is recorded by the image recording device of the present invention, the image reproducing device can reconstruct and reproduce the image captured according to the second method, using both of the first compressed image data in the first folder and the second compressed image data in the second folder.

In addition, the image recording device according to the present invention records a data range of the second compressed image data that is associated with a data range of the first compressed image data, in order to be associated with the data range of the first compressed image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. As a result, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of the image captured according to the second method can edit the playlist of the image captured according to the second method and then recorded to the recording medium by the image recording device according to the present invention. This means that the image recording device according to the present invention can record the image captured according to the second method (high-accuracy image) for which a playlist can be edited by the image reproducing device having the conventional standard.

It is also possible that the first captured image has a first frame rate, the second captured image has a second frame rate higher than the first frame rate, the first compression unit is configured to generate the first compressed image data by compressing frames that are included in the signals of the second captured image and that are equivalent to image having the first frame rate, and the second compression unit is configured to generate the second compressed image data by compressing the other frames included in the signals of the second captured image except the frames equivalent to image having the first frame rate.

With the above structure, the image data having the first frame rate is recorded in the first folder, and image data having the second frame rate except image data of frames equivalent to image having the first frame rate is recorded in the second folder. Thereby, when an image reproducing device having a conventional standard that does not support reproduction of the high-speed captured image reproduces a recording medium on which the high-speed captured image is recorded by the image recording device of the present invention, the image reproducing device having the conventional standard can reproduce the image having the first frame rate by reproducing the image data stored in the first folder. As a result, the image recording device according to the present invention can ensure compatibility with the image reproducing device having the conventional standard.

Furthermore, when an image reproducing device that supports reproduction of high-speed captured image reproduces a recording medium on which the high-speed captured image is recorded by the image recording device of the present invention, the image reproducing device can reconstruct and reproduce the high-speed captured image by deompressing and synthesizing the first compressed image data in the first folder and the second compressed image data in the second folder.

In addition, the image recording device according to the present invention records a data range of the second compressed image data that is associated with a data range of the first compressed image data, in order to be associated with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. As a result, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of high-speed captured image can edit a playlist of the high-speed captured image recorded to the recording medium by the image recording device according to the present invention. This means that the image recording device according to the present invention can record high-speed captured image for which a playlist can be edited by the image reproducing device having the conventional standard.

It is further possible that the image recording device further includes a mode switching unit configured to switch between a first capturing mode and a second capturing mode, the first capturing mode being used for capturing the first captured image and recording the first captured image to the recording medium, and the second capturing mode being used for capturing the second captured image and recording the second captured image to the recording medium, wherein at the first capturing mode, the image signal processing unit is configured to generate signals of the first captured image having the first frame rate from the electrical signals converted by the imaging element, the first compression unit is configured to generate third compressed image data by compressing the signals of the first captured image, and the recording unit is configured to record the third compressed image data in association with the first folder, wherein the recording unit is configured to record the first compressed image data generated at the second capturing mode and the third compressed image data generated at the first capturing mode to respective different files.

With the above structure, even if a capturing mode is switched to another capturing mode during capturing image, a file of the first compressed image data is associated with a file of the second compressed image data having a one-to-one relationship. Thereby, using only the first playlist specifying the procedure for reproducing the first compressed image data, it is possible to easily manage the procedure for reproducing the second compressed image data.

It is still further possible that the recording unit is configured to assign a file name to (i) a file in which the first compressed image data is recorded, and a file name to (ii) a file in which the second compressed image data is recorded, in order to specify a one-to-one relationship between (i) the file in which the first compressed image data is recorded and (ii) the file in which the second compressed image data is recorded.

With the above structure, it is possible to specify, according to the file names, the second compressed image data associated with the first compressed image data. Thereby, the second compressed image data associated with the first compressed image data designated by the first playlist can be easily specified. As a result, using only the playlist specifying a procedure for reproducing the first compressed image data, it possible to easily manage a procedure for reproducing the second compressed image data.

It is still further possible that when the part of the first compressed image data which is generated from a first frame to a second frame according to the first frame rate in the second captured image is recorded to the recording medium, the recording unit is configured to record, as the part of the second compressed image data associated with the part of the first compressed image data, the part of the second compressed image data which is generated from frames according to the second frame rate in the second captured image ranging from a frame immediately after the first frame to a frame immediately prior to a third frame, and the third frame is a frame subsequent to the second frame according to the first frame rate.

With the above structure, a data range of the second compressed image data associated with a data range of the first compressed image data is recorded in association with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data.

It is still further possible that the recording unit is configured not to record a second playlist in association with the second folder, the second playlist specifying a procedure for reproducing the second compressed image data.

With the above structure, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of high-speed captured image can edit a playlist of the high-speed captured image recorded to the recording medium by the image recording device according to the present invention. This means that the image recording device according to the present invention can record high-speed captured image for which a playlist can be edited by the image reproducing device having the conventional standard.

It is still further possible that the first captured image has a first resolution, and the second captured image has a second resolution higher than the first resolution, the image recording device further including a first-resolution conversion unit configured to convert the second resolution of the signals of the second captured image so as to generate signals of the first captured image having the first resolution as the first image information, wherein the first compression unit is configured to generate the first compressed image data including first compression information, by compressing the signals of the first captured image using the first compression information, and the second compression unit is configured to generate the second compressed image data by compressing the signals of the second captured image using the first compression information.

With the above structure, the image data having the first resolution is recorded in the first folder, and the image data having the second resolution is recorded in the second folder. Thereby, when an image reproducing device having a conventional standard that does not support reproduction of the high-resolution image reproduces a recording medium on which the high-resolution image is recorded by the image recording device of the present invention, the image reproducing device having the conventional standard can reproduce the image having the first resolution by reproducing the image data stored in the first folder. As a result, the image recording device according to the present invention can ensure compatibility with the image reproducing device having the conventional standard.

Furthermore, when an image reproducing device that supports reproduction of high-resolution image reproduces a recording medium on which high-resolution image is recorded by the image recording device according to the present invention, the image reproducing device can reconstruct and reproduce the high-resolution image by decompressing the second compressed image data recorded in the second folder.

In addition, the image recording device according to the present invention records a data range of the second compressed image data that is associated with a data range of the first compressed image data, in order to associated with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. As a result, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of high-resolution image can edit a playlist of high-resolution image recorded to the recording medium by the image recording device according to the present invention. This means that the image recording device according to the present invention can record high-resolution image for which a playlist can be edited by the image reproducing device having the conventional standard.

In addition, the image recording device according to the present invention generates the second compressed image data using the first compression information included in the first compressed image data. Thereby, the second compressed image data does not need to include information used in compressing the first compressed image data, which can increase compression efficiency of the second compressed image data.

It is still further possible that the image recording device further includes a mode switching unit configured to switch between a first capturing mode and a second capturing mode, the first capturing mode being used for capturing the first captured image and recording the first captured image to the recording medium, and the second capturing mode being used for capturing the second captured image and recording the second captured image to the recording medium, wherein at the first capturing mode, the image signal processing unit is configured to generate signals of third captured image having the first resolution from the electrical signals converted by the imaging element, the first compression unit is configured to generate third compressed image data by compressing the signals of the third captured image, and the recording unit is configured to record the third compressed image data in association with the first folder, wherein the recording unit is configured to record the first compressed image data generated at the second capturing mode and the third compressed image data generated at the first capturing mode to respective different files.

With the above structure, even if a capturing mode is switched to another capturing mode during capturing image, a file of the first compressed image data is associated with a file of the second compressed image data having a one-to-one relationship. Thereby, using only the first playlist specifying the procedure for reproducing the first compressed image data, it is possible to easily manage the procedure for reproducing the second compressed image data.

It is also possible that the recording unit is configured to assign a file name to (i) a file in which the first compressed image data is recorded, and a file name to (ii) a file in which the second compressed image data is recorded, in order to specify a one-to-one relationship between (i) the file in which the first compressed image data is recorded and (ii) the file in which the second compressed image data is recorded.

With the above structure, it is possible to specify, according to the file names, the second compressed image data associated with the first compressed image data. Thereby, the second compressed image data associated with the first compressed image data designated by the first playlist can be easily specified. As a result, using only the first playlist specifying the procedure for reproducing the first compressed image data, it possible to easily manage the procedure for reproducing the second compressed image data.

It is still further possible that the recording unit is configured not to record a second playlist in association with the second folder, the second playlist specifying a procedure for reproducing the second compressed image data.

With the above structure, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of high-resolution image can edit a playlist of high-resolution image recorded to the recording medium by the image recording device according to the present invention. This means that the image recording device according to the present invention can record high-resolution image for which a playlist can be edited by the image reproducing device having the conventional standard.

In accordance with another aspect of the present invention, there is provided an image reproducing device that reproduces a second captured image recorded in a recording medium, the second captured image being captured according to a second method to have an accuracy higher than an accuracy of a first captured image captured according to a first method, and the recording medium being initialized to have a file system and being removable from the image reproducing device, the image reproducing device including: a readout unit configured to read out first compressed image data and second compressed image data, the first compressed image data being recorded in the recording medium in association with a first folder in the file system, and the second compressed image data being recorded in the recording medium in association with a second folder in the file system; a first decompression unit configured to generate first image data by decompressing the first compressed image data; a second decompression unit configured to generate second image data by decompressing the second compressed image data; an image signal processing unit configured to generate signals of the second captured image captured according to the second method from the first image data and the second image data; a reproducing unit configured to reproduce the signals of the second captured image; and a reproduction control unit configured to control reproduction of the first compressed image data and the second compressed image data associated with the first compressed image data by a reproduction procedure included in a playlist recorded in association with the first folder, wherein the first compressed image data is generated by compressing first image information that is image information included in the second captured image and that is equivalent to the first captured image, and the second compressed image data is generated by compressing second image information that is image information included in the second captured image except at least a part of the image information included in the first image information.

With the above structure, the image reproducing device according to the present invention can reconstruct and reproduce the image captured according to the second method from the recording medium on which the image captured according to the second method is recorded.

In addition, regarding the image captured according to the second method and then recorded on the recording medium by the image recording device according to the present invention, the image reproducing device according to the present invention can reconstruct and reproduce the image by a reproduction procedure specified in the first playlist that have been edited by an image edit device in conformity to a conventional standard that does not support edit processing for image captured according to the second method.

It is also possible that the first captured image has a first frame rate, the second captured image has a second frame rate higher than the first frame rate, the first compressed image data is generated by compressing frames that are included in the second captured image and that are equivalent to image having the first frame rate, the second compressed image data is generated by compressing the other frames included in the second captured image except the frames equivalent to image having the first frame rate, and the image signal processing unit is configured to generate the signals of the second captured image by synthesizing the first image data with the second image data, when the second compressed image data is recorded on the recording medium.

With the above structure, the image reproducing device according to the present invention can reconstruct high-speed captured image from the recording medium on which the high-speed captured image is recorded, and then perform smooth slow playback of the reconstructed image.

In addition, regarding the high-speed captured image recorded to the recording medium by the image recording device according to the present invention, the image reproducing device according to the present invention can reconstruct and reproduce the high-speed captured image by a reproduction procedure specified in the first playlist that have been edited by an image edit device in conformity to a conventional standard that does not support edit processing for high-speed captured image, and then perform smooth slow playback of the reconstructed image.

It is further possible that when a part of the first compressed image data which is generated from a first frame to a second frame according to the first frame rate in the second captured image is reproduced, the reproduction control unit is configured to perform the control to reproduce a part of the second compressed image data which is generated from frames according to the second frame rate in the second captured image ranging from a frame immediately after the first frame to a frame immediately prior to a third frame, and the third frame is a frame subsequent to the second frame according to the first frame rate.

With the above structure, using the first playlist, it is possible to reproduce the first compressed image data and the second compressed image data associated with the first compressed image data.

It is still further possible that the first captured image has a first resolution, the second captured image has a second resolution higher than the first resolution, the first decompression unit is configured to generate the first image data by decompressing the first compressed image data using first compression information included in the first compressed image data, and the second decompression unit is configured to generate the second image data by decompressing the second compressed image data using the first compression information.

With the above structure, the image reproducing device according to the present invention can reconstruct and reproduce high-resolution image and normal-resolution image from the recording medium on which the high-resolution image is recorded.

In addition, regarding the high-resolution image recorded to the recording medium by the image recording device according to the present invention, the image reproducing device according to the present invention can reconstruct and reproduce the high-resolution image by a reproduction procedure specified in the first playlist that have been edited by an image edit device in conformity to a conventional standard that does not support edit processing for high-resolution image.

In accordance with still another aspect of the present invention, there is provided a recording medium on which a second captured image is recorded, the second captured image being captured according to a second method to have an accuracy higher than an accuracy of a first captured image captured according to a first method, and the recording medium being initialized to have a file system and being removable from an image recording device and an image reproducing device, the recording medium including: a first folder and a second folder in the file system; first compressed image data and a first playlist which are recorded in association with the first folder, the first compressed image data being generated by compressing first image information that is image information included in the second captured image and that is equivalent to the first captured image, and the first playlist specifying a procedure for reproducing the first compressed image data; and second compressed image data recorded in association with the second folder, the second compressed image data being generated by compressing second image information that is image information included in the second captured image except at least a part of the image information included in the first image information, wherein a part of the first compressed image data and a part of the second compressed image data are recorded in association with each other on the recording medium, the part of the first compressed image data and the part of the second compressed image data being generated from a part of the second captured image which is captured during a same time period of a first time unit, and during one unit of the first time unit, (i) one frame according to the first method and (ii) at least one frame according to the second method are included in the part of the second captured image.

With the above structure, the image data according to the first method that is a conventional standard is recorded in the first folder, and a part of the image data according to the second method is recorded in the second folder. Thereby, when an image reproducing device having a conventional standard that does not support reproduction of the image captured according to the second method reproduces the recording medium of the present invention, the image reproducing device having the conventional standard can reproduce the image captured according to the first method by reproducing the image data stored in the first folder. As a result, the recording medium according to the present invention can ensure compatibility with the image reproducing device having the conventional standard.

Furthermore, when an image reproducing device that supports reproduction of the image captured according to the second method reproduces the recording medium of the present invention, the image reproducing device can reconstruct and reproduce the image captured according to the second method (high-speed captured image), using the first compressed image data in the first folder and the second compressed image data in the second folder.

In addition, on the recording medium according to the present invention, a data range of the second compressed image data associated with a data range of the first compressed image data is recorded in association with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. Therefore, it is possible that, on the recording medium according to the present invention, a playlist is recorded only in the first folder and not in the second folder. In other words, it is possible to set a format of the playlist to be the same as the conventional format. Thereby, an image reproducing device in conformity to a conventional standard that does not support reproduction of the image captured according to the second method can edit the playlist of the image captured according to the second method and then recorded to the recording medium according to the present invention. This means that, on the recording medium according to the present invention, the image reproducing device having the conventional standard can edit the playlist.

It is also possible that the first captured image has a first frame rate, the second captured image has a second frame rate higher than the first frame rate, the first compressed image data is generated by compressing frames that are included in the second captured image and that are equivalent to image having the first frame rate, and the second compressed image data is generated by compressing the other frames included in the second captured image except the frames equivalent to image having the first frame rate.

With the above structure, the image data having the first frame rate is recorded in the first folder, and image data having the second frame rate except image data of frames equivalent to image having the first frame rate is recorded in the second folder. Thereby, when an image reproducing device having a conventional standard that does not support reproduction of the high-speed captured image reproduces the recording medium of the present invention, the image reproducing device having the conventional standard can reproduce the image having the first frame rate by reproducing the image data stored in the first folder. As a result, the recording medium according to the present invention can ensure compatibility with the image reproducing device having the conventional standard.

Furthermore, when an image reproducing device that supports reproduction of high-speed captured image reproduces the recording medium of the present invention, the image reproducing device can reconstruct and reproduce the high-speed captured image by decompressing and synthesizing the first compressed image data in the first folder and the second compressed image data in the second folder.

In addition, on the recording medium according to the present invention, a data range of the second compressed image data associated with a data range of the first compressed image data is recorded in association with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. Therefore, it is possible that, on the recording medium according to the present invention, a playlist is recorded only in the first folder and not in the second folder. In other words, it is possible to set a format of the playlist to be the same as the conventional format. Thereby, an image reproducing device in conformity to a conventional standard that does not support reproduction of high-speed captured image can edit a playlist of the high-speed captured image recorded to the recording medium according to the present invention. This means that, on the recording medium according to the present invention, the image reproducing device having the conventional standard can edit the playlist.

It is further possible that a second playlist is not recorded in association with the second folder, the second playlist specifying a procedure for reproducing the second compressed image data.

With the above structure, the image recording device according to the present invention records a playlist only in the first folder, and does not record a playlist in the second folder. In other words, it is possible to set a format of the playlist to be the same as the conventional format. Thereby, an image reproducing device in conformity to a conventional standard that does not support reproduction of high-speed captured image can edit a playlist of the high-speed captured image recorded to the recording medium by the image recording device according to the present invention. This means that the image recording device according to the present invention can record high-speed captured image for which a playlist can be edited by the image reproducing device having the conventional standard.

It is still further possible that the first captured image has a first resolution, the second captured image has a second resolution higher than the first resolution, the first compressed image data is generated by compressing the first captured image and includes first compression information used in the compression of the first captured image, and the second compressed image data is generated by compressing the second captured image using the first compression information.

With the above structure, the image data having the first resolution is recorded in the first folder, and the image data having the second resolution is recorded in the second folder. Thereby, when an image reproducing device having a conventional standard that does not support reproduction of high-resolution image reproduces the recording medium of the present invention, the image reproducing device having the conventional standard can reproduce the image having the first resolution by reproducing the image data stored in the first folder. As a result, the recording medium according to the present invention can ensure compatibility with the image reproducing device having the conventional standard.

Furthermore, when an image reproducing device that supports reproduction of high-resolution image reproduces the recording medium of the present invention, the image reproducing device can reconstruct and reproduce the high-resolution image by decompressing the first compressed image data in the first folder and the second compressed image data in the second folder.

In addition, on the recording medium according to the present invention, a data range of the second compressed image data associated with a data range of the first compressed image data is recorded in association with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. Therefore, it is possible that, on the recording medium according to the present invention, a playlist is recorded only in the first folder and not in the second folder. In other words, it is possible to set a format of the playlist to be the same as the conventional format. Thereby, an image reproducing device in conformity to a conventional standard that does not support reproduction of high-resolution image can edit a playlist of high-resolution image recorded to the recording medium according to the present invention. This means that, on the recording medium according to the present invention, the image reproducing device having the conventional standard can edit the playlist.

In accordance with still another aspect of the present invention, there is provided an image recording method used in an image recording device that captures a second captured image and records the second captured image to a recording medium, the second captured image being a high-speed captured image and being captured according to a second method to have an accuracy higher than an accuracy of a first captured image captured according to a first method, and the recording medium being initialized to have a file system and being removable from the image recording device, the image recording method including: generating signals of the second captured image according to the second method from electrical signals converted from incident light signals by an imaging element; generating first compressed image data by compressing first image information that is image information included in the signals of the second captured image and that is equivalent to the first captured image; generating second compressed image data by compressing second image information that is image information included in the signals of the second captured image except at least a part of the image information included in the first image information; and recording the first compressed image data and the second compressed image data to the recording medium, wherein the recording includes: (i) creating a first folder and a second folder in the file system; (ii-1) recording the first compressed image data and a first playlist in association with the first folder; and (ii-2) recording the second compressed image data in association with the second folder, the first playlist specifying a procedure for reproducing the first compressed image data, wherein in the recording, a part of the first compressed image data and a part of the second compressed image data are recorded in association with each other, the part of the first compressed image data and the part of the second compressed image data being generated from a part of the second captured image which is captured during a same time period of a first time unit, and during one unit of the first time unit, (i) one frame according to the first method and (ii) at least one frame according to the second method are included in the part of the second captured image.

With the above method, the image data according to the first method that is a conventional standard is recorded in the first folder, and a part of the image data according to the second method is recorded in the second folder. Thereby, when an image reproducing device having a conventional standard that does not support reproduction of the image captured according to the second method reproduces a recording medium on which the image data captured according to the second method is recorded by the image recording method of the present invention, the image reproducing device having the conventional standard can reproduce the image captured according to the first method by reproducing the image data stored in the first folder. As a result, the image recording method according to the present invention can ensure compatibility with the image reproducing device having the conventional standard.

Furthermore, when an image reproducing device that supports reproduction of image captured according to the second method reproduces a recording medium on which the image captured according to the second method is recorded by the image recording device of the present invention, the image reproducing device can reconstruct and reproduce the image captured according to the second method, using both of the first compressed image data in the first folder and the second compressed image data in the second folder.

In addition, by the image recording method according to the present invention, a data range of the second compressed image data associated with a data range of the first compressed image data is recorded in association with the data range of the first compression image data. In other words, a file of the first compressed image data is associated with a file of the second compressed image data, having a one-to-one relationship. Thereby, using only the first playlist specifying the procedure for reproducing the first compressed image data, it is possible to easily manage the procedure for reproducing the second compressed image data. As a result, by the image recording method according to the present invention, a playlist is recorded only in the first folder, not in the second folder. Thereby, an image reproducing device in conformity to a conventional standard that does not support reproduction of the image captured according to the second method can edit the playlist of the image captured according to the second method and then recorded to the recording medium by the image recording method according to the present invention. This means that, by the image recording method according to the present invention, it is possible to record the image captured according to the second method (high-accuracy image) for which a playlist can be edited by the image reproducing device having the conventional standard.

It should be noted that the present invention can be implemented not only as the image recording device and the image reproducing device including the above characteristic units, but also as: an image recording method and an image reproducing method including steps performed by the characteristic units of the image recording device and the image reproducing device: a program causing a computer to execute the characteristic steps; and the like. Of course, the program can be distributed by a recording medium such as a Compact Disc-Read Only Memory (CD-ROM) or by a transmission medium such as the Internet.

Accordingly, the present invention can provide: an image recording device capable of generating and recording high-speed captured image or high-accuracy image for which image reproducing devices having conventional standards can edit playlists; a recording medium on which the high-speed captured image or the high-accuracy image for which image reproducing devices having conventional standards can edit playlists is recorded; and an image reproducing device that reproduces the high-speed captured image or the high-accuracy image recorded on the recording medium.

Further Information about Technical Background to this Application

The disclosure of Japanese Patent Application No. 2008-014193 filed on Jan. 24, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a perspective external view of an image recording/reproducing device according to a first embodiment of the present invention;

FIG. 2 is a diagram showing a hardware structure of the image recording/reproducing device according to the first embodiment of the present invention;

FIG. 3 is a block diagram showing structures of an image signal processing unit, a first compression multiplex unit, and a second compression multiplex unit according to the first embodiment of the present invention;

FIG. 4 is a flowchart of recording processing performed by the image recording/reproducing device according to the first embodiment of the present invention;

FIG. 5 is a schematic diagram of processing performed by the signal processing unit, the first compression multiplex unit, and the second compression multiplex unit according to the first embodiment of the present invention;

FIG. 6 is a diagram showing an example of a file structure of files recorded in a recording medium according to the first embodiment of the present invention;

FIG. 7 is a flowchart of reproduction processing performed by the image recording/reproducing device according to the first embodiment of the present invention;

FIG. 8 is a diagram for explaining relationships among files in and below a BDMV main folder in the file structure of FIG. 6;

FIG. 9 is a diagram for explaining relationships among files in and below the BDMV main folder and files in and below a HIGHRATE main folder in the file structure of FIG. 6;

FIG. 10 is a diagram showing relationships among files recorded in switching between the capturing modes in the image recording/reproducing device according to the first embodiment of the present invention;

FIG. 11 is a block diagram showing structures of an image signal processing unit, a first compression multiplex unit, and a second compression multiplex unit according to a second embodiment of the present invention;

FIG. 12 is a diagram showing processing performed by the first compression multiplex unit and the second compression multiplex unit for generating prediction image according to the second embodiment of the present invention;

FIG. 13 is a diagram showing an example of a file structure of files recorded in a recording medium according to the second embodiment of the present invention;

FIG. 14 is a flowchart of reproduction processing performed by the image recording/reproducing device according to the second embodiment of the present invention; and

FIG. 15 is a diagram for explaining relationships among files in and below the BDMV main folder and files in and below a HIGHESO main folder in the file structure of FIG. 13.

### DESCRIPTION OF THE PREFERRED EMBODIMENT(S)

The following describes image recording/reproducing devices according to embodiments of the present invention with reference to the drawings.

### First Embodiment

An image recording/reproducing device according to a first embodiment of the present invention records image having a frame rate of 30 fps included in high-speed captured image to a folder having a structure having compatibility with a conventional standard, and records other image included in the high-speed captured image to a different folder. Thereby, the image recording/reproducing device according to the first embodiment of the present invention can ensure compatibility with image reproducing devices having the conventional standard and can record high-speed captured image to be easily managed.

Moreover, the image recording/reproducing device according to the first embodiment of the present invention generates and records playlists only in the folder having the structure having compatibility with the conventional standard. Thereby, the image recording/reproducing device according to the first embodiment of the present invention can record high-speed captured image so that image reproducing devices having the conventional standard can edit a playlist regarding the high-speed captured image.

Firstly, a structure of the image recording/reproducing device according to the first embodiment of the present invention is described.

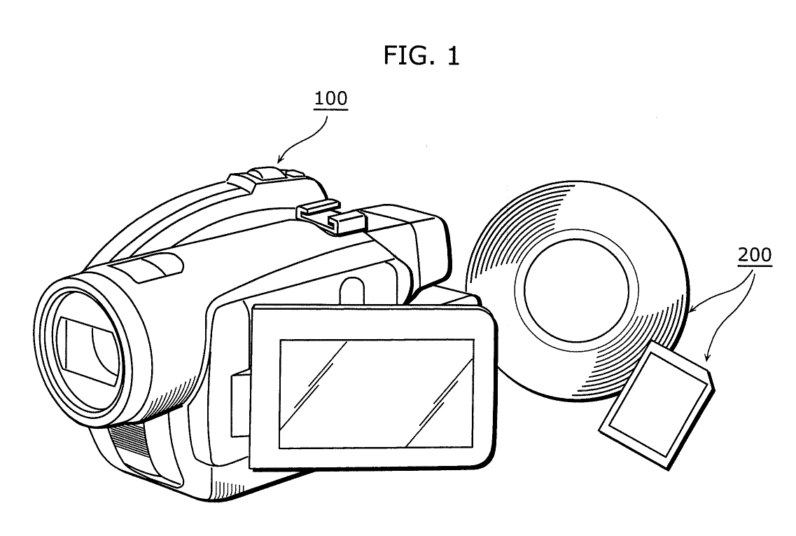

FIG. 1 is a perspective external view of an image recording/reproducing device according to a first embodiment of the present invention. As shown in FIG. 1, the image recording/reproducing device 100 is a digital video camera, for example. The image recording/reproducing device 100 has a function of serving as an image recording device that records captured high-speed captured image to a recording medium 200. In addition, the image recording/reproducing device 100 has another function of serving as an image reproducing device that reproduces the high-speed captured image recorded on the recording medium 200.

The recording medium 200 is removable from the image recording/reproducing device 100. Examples of the recording medium 200 are a semiconductor memory, an optical disk, and the like. The recording medium 200 is initialized by at least one file system.

The image recording/reproducing device 100 can switch between (i) a normal capturing mode for capturing an object at a frame rate of 30 fps and (ii) a high-speed capturing mode for capturing an object at a frame rate of 300 fields per second. Further, the image recording/reproducing device 100 can switch between (i) a normal reproduction mode for reproducing only image data which is included in image data captured at the normal capturing mode and is compatible to a frame rate of 30 fps and (ii) a high-speed reproduction mode for performing slow playback of image data captured at the high-speed capturing mode. Furthermore, the image recording/reproducing device 100 can reproduce image data captured at the normal capturing mode, at a frame rate of 30 fps.

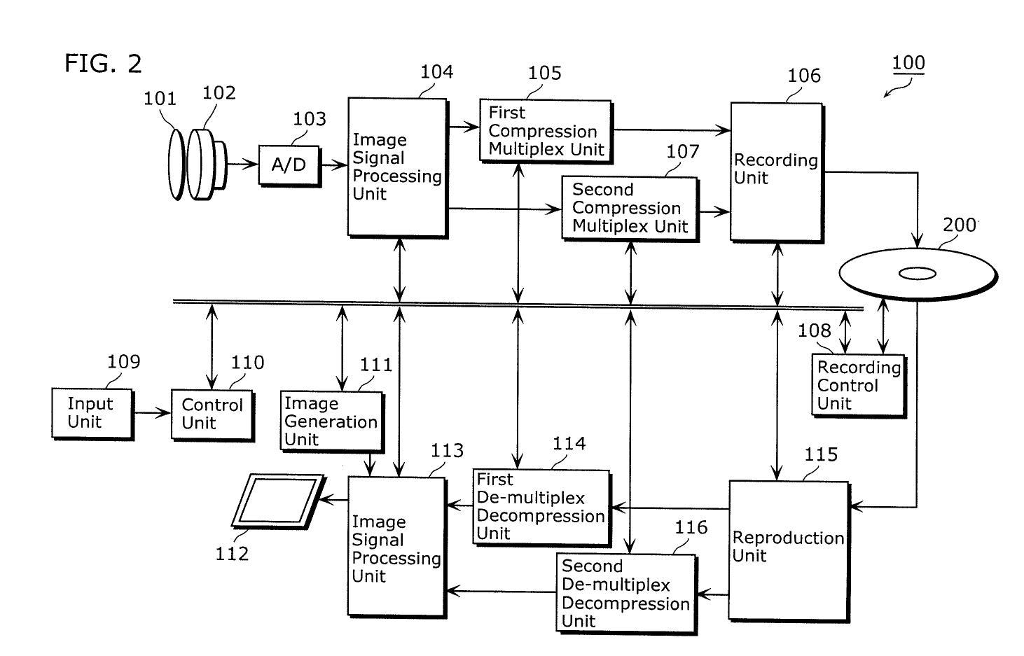

FIG. 2 is a block diagram showing a hardware structure of the image recording/reproducing device 100 according to the first embodiment of the present invention. As shown in FIG. 2, the image recording/reproducing device 100 includes a lens group 101, an imaging unit 102, an A/D conversion unit 103, an image signal processing unit 104, a first compression multiplex unit 105, a recording unit 106, a second compression multiplex unit 107, a recording control unit 108, an input unit 109, a control unit 110, an image generation unit 111, a display unit 112, an image signal processing unit 113, a first de-multiplex decompression unit 114, an reproduction unit 115, and a second de-multiplex decompression unit 116.

The lens group 101 includes a plurality of optical lenses. The lens group 101 collects light on the imaging unit 102.

The imaging unit 102 includes imaging elements and the like. The imaging unit 102 images light received via the lens group 101. In more detail, the imaging unit 102 converts the received light signals to analog signals (electric signals) and provides the analog signals to the A/D conversion unit 103.

The A/D conversion unit 103 converts the analog signals received from the imaging unit 102 to digital signals. The A/D conversion unit 103 provides the resulting digital signals to the image signal processing unit 104.

The image signal processing unit 104 performs image signal processing, such as noise cancellation and image quality adjustment, on the digital signals provided from the A/D conversion unit 103 in order to generate image signals. At the normal capturing mode, the image signal processing unit 104 performs image signal processing on the digital signals to generate normal captured image signals having a frame rate of 30 fps and provides the generated signals to the first compression multiplex unit 105. On the other hand, at the high-speed capturing mode, the image signal processing unit 104 performs image signal processing on the digital signals to generate high-speed captured image signals having a frame rate of 300 fields per second. From among the high-speed captured image signals, the image signal processing unit 104 provides image signals of frames equivalent to image having a frame rate of 30 fps to the first compression multiplex unit 105, and provides image signals of other frames to the second compression multiplex unit 107.

Using a coding method such as MPEG-2 or H.264, the first compression multiplex unit 105 compresses and multiplexes the image signals captured at a frame rate of 30 fps which are provided from the image signal processing unit 104. The first compression multiplex unit 105 provides, as a normal content, the generated compressed image data to the recording unit 106.

Using a coding method such as MPEG-2 or H.264, the second compression multiplex unit 107 compresses and multiplexes the image signals of the other frames except the frames equivalent to image having a frame rate of 30 fps which are provided from the image signal processing unit 104. The second compression multiplex unit 107 provides, as high-speed image sub-data, the resulting compressed image data to the recording unit 106.

The recording unit 106 records (i) the normal content provided from the first compression multiplex unit 105 and (ii) the high-speed image sub-data provided from the second compression multiplex unit 107 to the recording medium 200.

The recording control unit 108 controls a drive device driving the recording medium 200 or recording protocols such as a recording address input procedure.

The input unit 109 receives a user's operation via input devices. The input unit 109 provides, as operation information, the received user operation to the control unit 110.

The control unit 110 controls the image signal processing unit 104, the first compression multiplex unit 105, the recording unit 106, the second compression multiplex unit 107, the recording control unit 108, the image generation unit 111, the image signal processing unit 113, the first de-multiplex decompression unit 114, the reproduction unit 115, and the second de-multiplex decompression unit 116, in order to perform recording processing and reproduction processing in the image recording/reproducing device 100.

The image generation unit 111 generates a menu image showing a list of contents recorded in the recording medium 200.

The reproduction unit 115 reads out from the recording medium 200 a normal content to be reproduced, and provides the normal content to the first de-multiplex decompression unit 114. The reproduction unit 115 reads out from the recording medium 200 a high-speed image sub-data associated with the normal content to be reproduced, and provides the obtained sub-data to the second de-multiplex decompression unit 116.

Using the same coding method such as MPEG-2 or H.264 as the coding method used in the first compression multiplex unit 105, the first de-multiplex decompression unit 114 de-multiplexes and decompresses the normal content provided from the reproduction unit 115. The first de-multiplex decompression unit 114 provides the resulting decompressed normal content to the image signal processing unit 113.

Using the same coding method such as MPEG-2 or H.264 as the coding method used in the second compression multiplex unit 107, the second de-multiplex decompression unit 116 de-multiplexes and decompresses the high-speed image sub-data provided from the reproduction unit 115. The second de-multiplex decompression unit 116 provides the resulting decompressed high-speed image sub-data to the image signal processing unit 113.

When the normal reproduction mode is designated, the image signal processing unit 113 performs processing, such as image quality adjustment for display, on the decompressed normal content provided from the first de-multiplex decompression unit 114, thereby generating normal reproduction image. The image signal processing unit 113 provides the generated normal reproduction image to the display unit 112.

When the high-speed reproduction mode is designated and the high-speed image sub-data is provided from the second de-multiplex decompression unit 116, the image signal processing unit 113 synthesizes the decompressed normal content and the decompressed high-speed image sub-data together to generate slow playback image, and provides the generated slow playback image to the display unit 112.

If necessary, the image signal processing unit 113 provides, as image signals, the menu image and the like generated by the image generation unit 111 to the display unit 112, without performing any processing on the menu image and the like, or by multiplexing the menu image and the like by the decompressed normal reproduction image provided from the first de-multiplex decompression unit 114.

The display unit 112 reproduces the normal reproduction image, the slow playback image, the menu image, or image signals including the menu image, and displays the reproduced image on a monitor or the like.

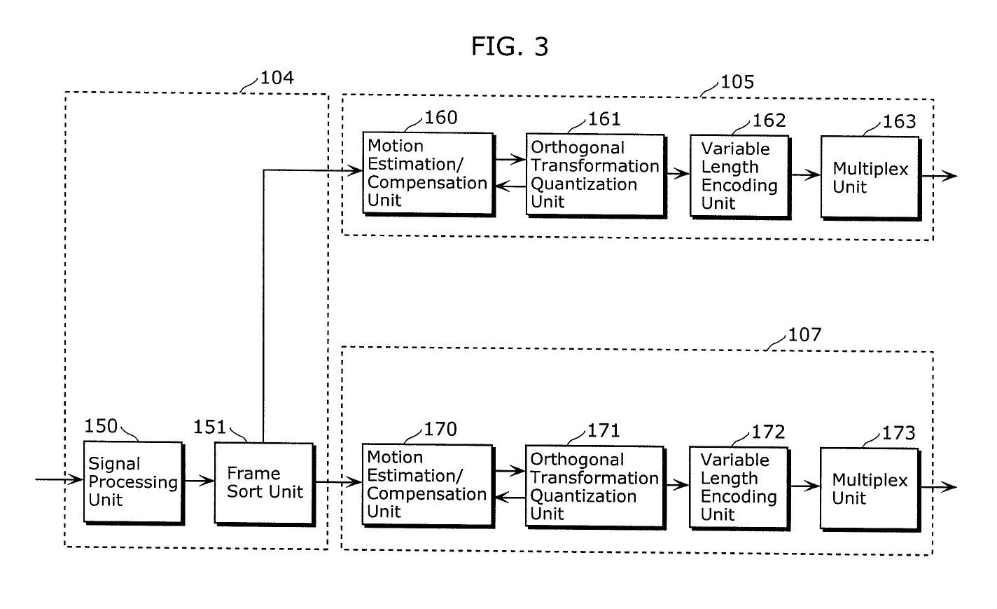

FIG. 3 is a block diagram showing structures of the image signal processing unit 104, the first compression multiplex unit 105, and the second compression multiplex unit 107.

The image signal processing unit 104 includes a signal processing unit 150 and a frame sort unit 151.

The signal processing unit 150 performs image signal processing, such as noise cancellation and image quality adjustment, on the digital signals provided from the A/D conversion unit 103 to generate image signals having a frame rate of 300 fps, and provides the generated image signals to the frame sort unit 151.

The frame sort unit 151 sorts the image signals having the frame rate of 300 fps to (i) image signals of frames equivalent to image having a frame rate of 30 fps and (ii) image signals of other frames. The frame sort unit 151 provides (i) the image signals of frames equivalent to image having a frame rate of 30 fps to the first compression multiplex unit 105, and (ii) the image signals of other frames to the second compression multiplex unit 107.

The first compression multiplex unit 105 includes the motion estimation/compensation unit 160, the orthogonal transformation quantization unit 161, the variable length encoding unit 162, and the multiplex unit 163.

The motion estimation/compensation unit 160 generates a prediction image using a result of motion estimation and reference image(s). The motion estimation/compensation unit 160 generates a prediction error that is a difference between (i) the generated prediction image and (ii) image signals of the frames that are equivalent to image having a frame rate of 30 fps provided from the frame sort unit 151.

The orthogonal transformation quantization unit 161 performs orthogonal transformation and quantization on the prediction error generated by the motion estimation/compensation unit 160, thereby generating quantized transformation coefficients. Further, the orthogonal transformation quantization unit 161 performs inverse quantization and inverse orthogonal transformation on the generated quantized transformation coefficients, thereby generating a prediction error.

The motion estimation/compensation unit 160 generates a reference image using the prediction error generated by the orthogonal transformation quantization unit 161.

The variable length encoding unit 162 performs variable length coding on the quantized transformation coefficients generated by the orthogonal transformation quantization unit 161 to generate compressed codes.

The multiplex unit 163 packetizes the compressed codes generated by the variable length encoding unit 162. The multiplex unit 163 multiplexes an audio packet and the like to the packetized compressed codes, thereby generating compressed image data in conformity to the conventional standard. The multiplex unit 163 provides, as a normal content, the generated compressed image data to the recording unit 106.

The second compression multiplex unit 107 includes a motion estimation/compensation unit 170, an orthogonal transformation quantization unit 171, a variable length encoding unit 172, and a multiplex unit 173.

The motion estimation/compensation unit 170 generates a prediction image using the result of the motion estimation and the reference image(s). The motion estimation/compensation unit 170 generates a prediction error that is a difference between (i) the generated prediction image and (ii) image signals of the other frames except the frames equivalent to image having the frame rate of 30 frames per second provided from the frame sort unit 151.

The orthogonal transformation quantization unit 171 performs orthogonal transformation and quantization on the prediction error generated by the motion estimation/compensation unit 170, thereby generating quantized transformation coefficients. Further, the orthogonal transformation quantization unit 171 performs inverse quantization and inverse orthogonal transformation on the generated quantized transformation coefficients, thereby generating a prediction error.

The motion estimation/compensation unit 170 generates a reference image using the prediction error generated by the orthogonal transformation quantization unit 171.

The variable length encoding unit 172 performs variable length coding on the quantized transformation coefficients generated by the orthogonal transformation quantization unit 171 to generate compressed codes.

The multiplex unit 173 packetizes the compressed codes generated by the variable length encoding unit 172. The multiplex unit 173 multiplexes an audio packet and the like to the packetized compressed codes, thereby generating compressed image data applied with hierarchy coding. The multiplex unit 173 provides, as high-speed image sub-data, the generated compressed image data to the recording unit 106.

Next, the processing performed by the image recording/reproducing device 100 is described.

Firstly, the recording processing performed by the image recording/reproducing device 100 is described.

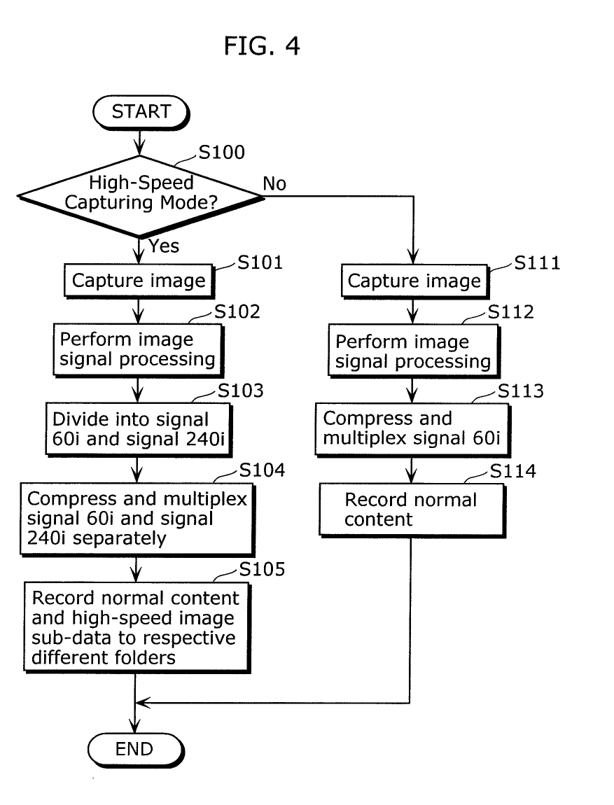

FIG. 4 is a flowchart of the recording processing performed by the image recording/reproducing device 100.

Firstly, the control unit 110 checks a capturing mode set by a user using the input unit 109 (S100).

If the capturing mode is the high-speed capturing mode (Yes at S100), then the imaging unit 102 images light received via the lens group 101 (S101). The imaging unit 102 converts signals of the received light to analog signals. The A/D conversion unit 103 converts the analog signals to digital signals.

Next, the image signal processing unit 104 performs image signal processing, such as noise cancellation and image quality adjustment, on the digital signals provided from the A/D conversion unit 103 in order to generate image signals (S102).

The image signal processing unit 104 divides the generated image signals into (i) frames equivalent to image having a frame rate of 30 fps and (ii) the other frames (S103).

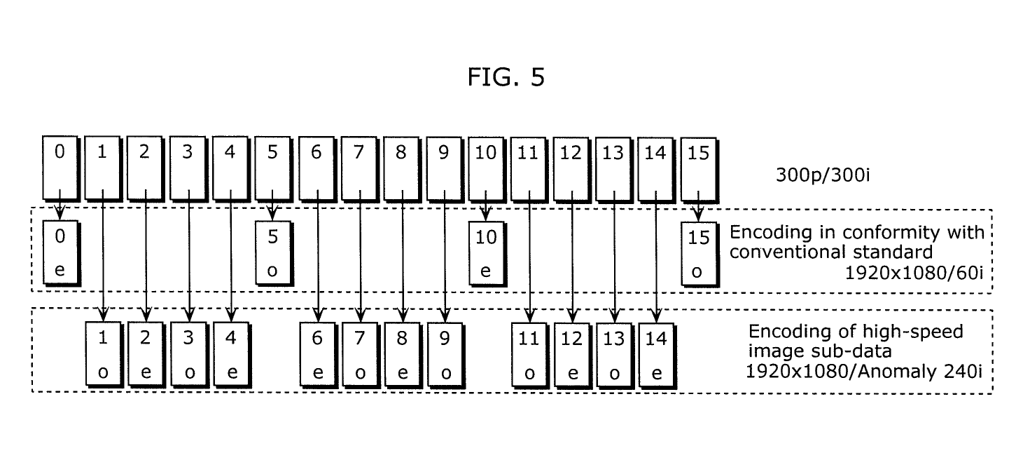

FIG. 5 is a schematic diagram of the processing performed by the signal processing unit 104, the first compression multiplex unit 105, and the second compression multiplex unit 107 according to the first embodiment of the present invention.

FIG. 5 shows an example where the image signal processing unit 104 generates image having a frame rate of 300 fps using progressive scanning (hereinafter, the images is referred to as “image 300 p”) or image having a frame rate of 300 fields per second using interlace scanning (hereinafter, the images is referred to as “image 300i”) from the signals provided via the lens group 101, the imaging unit 102, and the A/D conversion unit 103. Here, the image is assumed to be well-known high-resolution image having an image size of 1920×1080 pixels.

The signal processing unit 150 in the image signal processing unit 104 performs image signal processing, such as noise cancellation and image quality adjustment, on the digital signals provided from the A/D conversion unit 103 to generate image signals of the image 300p, and provides the generated image signals of the image 300p to the frame sort unit 151.

The frame sort unit 151 retrieves one frame every five frames from the image 300p. The frame sort unit 151 scans only even lines and then only odd lines alternately in each of the retrieved frame, so as to generate signals of interlaced image having a frame rate of 60 fields per second (30 frames per second) (hereinafter, referred to as “signal 60i”).

It is also possible that the frame sort unit 151 generates the signal 60i by retrieving one filed every five fields from the image 300i.

The signal 60i is video signal in conformity to a conventional standard, such as Blu-ray Disc (BD) or Advanced Video Codec High Definition (AVCHD). Therefore, the first compression multiplex unit 105 can perform compression coding using the conventional standard and record the result as a normal content to the recording medium 200 in a recording format in conformity to the conventional standard.

On the other hand, the frame sort unit 151 scans only even lines and then only odd lines alternately in each of remaining frames except the retrieved frames in the high-speed captured image 300p (in other words, each of four frames every five frames in the image 300p), so as to generate signals of interlaced image having a frame rate of 240 fields per second (hereinafter, referred to as “signal 240i”). Here, as shown in FIG. 5, in image having a frame rate of 240 fields per second, the fields are not at regular intervals, so that the signal is called anomaly signal 240i. It is also possible that the frame sort unit 151 generates the anomaly signal 240i by retrieving remains after retrieving the signal 60i from the high-speed captured image 300i (in other words, four fields every five fields in the image 300i).

The anomaly signal 240i is not conformity to the conventional standard. However, since correlation between frames or between fields remains, it is possible that the second compression multiplex unit 107 performs compression coding using a well-known hybrid coding such as MPEG-2 or H.264 and records the results as high-speed image sub-data to the recording medium 200 in a non-conventional unique format.

The first compression multiplex unit 105 and the second compression multiplex unit 107 compress and multiplex the signal 60i and the signal 240i, respectively, which are divided by the image signal processing unit 104 (S104). More specifically, the first compression multiplex unit 105 compresses and multiplexes the signal 60i to generate data of a normal content in conformity to the conventional standard. On the other hand, the second compression multiplex unit 107 compresses and multiplexes the signal 240i to generate high-speed image sub-data.

In more detail, the motion estimation/compensation unit 160 generates a prediction error that is a difference between (i) the generated prediction image and (ii) the signal 60i provided from the frame sort unit 151, and provides the generated prediction error to the orthogonal transformation quantization unit 161.

The orthogonal transformation quantization unit 161 performs orthogonal transformation and quantization on the prediction error provided from the motion estimation/compensation unit 160 thereby generating quantized transformation coefficients, and provides the generated quantized transformation coefficients to the variable length encoding unit 162. Further, the orthogonal transformation quantization unit 161 performs inverse quantization and inverse orthogonal transformation on the generated quantized transformation coefficients thereby generating a prediction error, and provides the resulting prediction error to the motion estimation/compensation unit 160.

The motion estimation/compensation unit 160 generates a reference image using the prediction error generated by the orthogonal transformation quantization unit 161.

The variable length encoding unit 162 performs variable length coding on the quantized transformation coefficients provided from the orthogonal transformation quantization unit 161 to generate compressed codes, and provides the generated compressed codes to the multiplex unit 163.

The multiplex unit 163 packetizes the compressed codes provided from the variable length encoding unit 162. The multiplex unit 163 multiplexes an audio packet and the like to the packetized compressed codes, thereby generating compressed image data in conformity to the conventional standard. The first compression multiplex unit 105 provides, as a normal content, the generated compressed image data to the recording unit 106.

On the other hand, the motion estimation/compensation unit 170 generates a prediction error that is a difference between (i) the generated prediction image and (ii) the anomaly signal 240i provided from the frame sort unit 151, and provides the generated prediction error to the orthogonal transformation quantization unit 171.

The orthogonal transformation quantization unit 171 performs orthogonal transformation and quantization on the prediction error provided from the motion estimation/compensation unit 170 thereby generating quantized transformation coefficients, and provides the generated quantized transformation coefficients to the variable length encoding unit 172. Further, the orthogonal transformation quantization unit 171 performs inverse quantization and inverse orthogonal transformation on the generated quantized transformation coefficients thereby generating a prediction error, and provides the resulting prediction error to the motion estimation/compensation unit 170.

The motion estimation/compensation unit 170 generates a reference image using the prediction error provided from the orthogonal transformation quantization unit 171.

The variable length encoding unit 172 performs variable length coding on the quantized transformation coefficients provided from the orthogonal transformation quantization unit 171 thereby generating compressed codes, and provides the generated compressed codes to the multiplex unit 173.

The multiplex unit 173 packetizes the compressed codes provided from the variable length encoding unit 172. The multiplex unit 173 multiplexes an audio packet and the like to the packetized compressed codes, thereby generating compressed image data. The second compression multiplex unit 107 provides, as high-speed image sub-data, the resulting compressed image data to the recording unit 106.

It should be noted that the first compression multiplex unit 105 and the second compression multiplex unit 107 may generate the normal content and the high-speed image sub-data, using hierarchy coding. In more detail, when the anomaly signal 240i is compression-coded, the first compression multiplex unit 105 and the second compression multiplex unit 107 may perform the compression coding only on the anomaly signal 240i separated from the signal 60i, or may perform the compression coding for the anomaly signal 240i and the signal 60i by hierarchy coding. In other words, the second compression multiplex unit 107 may generate a prediction image of the anomaly signal 240i by using a locally-decoded image generated in performing compression coding on the 60i signal. Thereby, compression efficiency of the anomaly signal 240i can be increased.

Next, the recording unit 106 records (i) the normal content generated by the first compression multiplex unit 105 and (ii) the high-speed image sub-data generated by the second compression multiplex unit 107, to respective different folders in the recording medium 200 (S105).

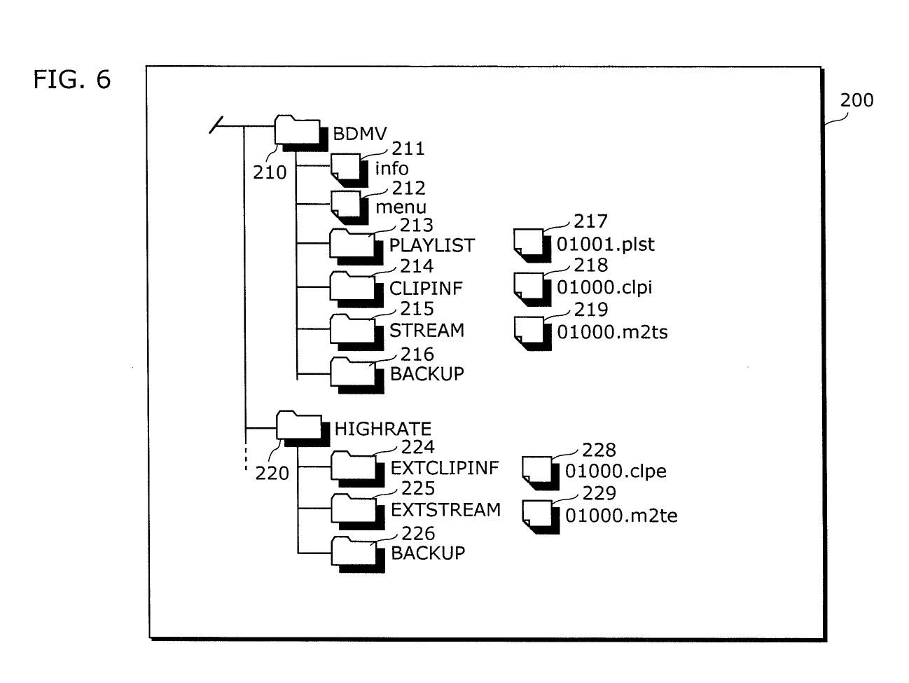

FIG. 6 is a diagram showing an example of a file structure of files recorded in the recording medium 200 according to the first embodiment of the present invention.

As shown in FIG. 6, in a file system for files recorded in the recording medium 200 there are a BDMV main folder 210 and a HIGHRATE main folder 220 at a highest hierarchy layer of a directory structure.

The BDMV main folder 210 is a folder for compatibility with a conventional standard. In the BDMV main folder 210, normal contents are recorded in a recording format in conformity to the conventional standard. On the other hand, the HIGHRATE main folder 220 is a folder for high-speed captured image. In the HIGHRATE main folder 220, the high-speed image sub-data is recorded in a non-conventional unique recording format.

Below the BDMV main folder 210, there are an information file 211 (info), a menu file 212 (menu), a playlist folder 213 (PLAYLIST), clipinfo folder 214 (CLIPINF), a stream folder 215 (STREAM), and a backup folder 216 (BACKUP).

The information file 211 (info) includes management information for managing the entire directory. The menu file 212 (menu) includes information for structuring a menu.

Below the playlist folder 212 (PLAYLIST), a playlist file 217 (01001.plst) is stored. The playlist file 217 (01001.plst) includes information for reproducing normal contents. In more detail, the playlist file 217 has information regarding an order of reproducing normal contents. In addition, the playlist file 217 includes (i) information for designating clipinfo files 218 and (ii) reproduction time information.

Below the clipinfo folder 214 (CLIPINF), a clipinfo file 218 (01000.clpi) is stored. The clipinfo file 218 (01000.clpi) includes information for reproducing a normal content. In more detail, the clipinfo file 218 indicates a relationship between time information and a position of image data (a stream file 219). Further, the clipinfo file 218 includes a time table for achieving partial playback and special playback of the corresponding image data.

Furthermore, the clipinfo file 218 includes information regarding the corresponding image data, such as an image size and a compression method.

Below the stream folder 215 (STREAM), a stream file 219 (01000.m2ts) is stored. The stream file 219 (01000.m2ts) is an audio-visual (AV) data file.

The backup folder 216 (BACKUP) holds copies of the information file 211 (info), the menu file 212 (menu), the playlist folder 213 (PLAYLIST), and the clipinfo folder 214 (CLIPINF), which are currently being edited. Thereby, it is possible to prevent that normal contents cannot be reproduced due to power discontinuity or the like in the middle of the editing.

Below the HIGHRATE main folder 220, there are a clipinfo folder 224 (EXTCLIPINF), a stream folder 225 (EXTSTREAM), and a backup folder 226 (BACKUP).

Below the clipinfo folder 224 (EXTCLIPINF), a clipinfo file 228 (01000.clpe) is stored. The clipinfo file 228 (01000.clpe) includes information for reproducing high-speed image sub-data. In more detail, the clipinfo file 228 indicates a relationship between time information and a position of image data (a stream file 229). In addition, the clipinfo file 228 includes a time table for achieving partial playback and special palyback of the corresponding image data. Furthermore, the clipinfo file 228 includes information regarding the corresponding image data, such as an image size and a compression method.

Below the stream folder 225 (EXTSTREAM), a stream file 229 (01000.m2te) is stored. The stream file 229 (01000.m2te) is a file of high-speed image sub-data.

The backup folder 226 (BACKUP) holds a copy of the clipinfo folder 224 (EXTCLIPINF) which is, for example, currently being edited.

Here, below the HIGHRATE main folder 220, there is neither a folder corresponding to the playlist folder 213 nor a folder corresponding to a playlist file 217. In other words, the control unit 110 does not control the recording unit 106 to record, below the HIGHRATE main folder 220, a playlist that includes information indicating a procedure for reproducing high-speed image sub-data and high-speed captured image.

As described above, at the high-speed capturing mode, the image recording/reproducing device 100 records (i) image data equivalent to image having a frame rate of 30 fps in conformity to the conventional standard from among image data having a frame rate of 300 fields per second, in or below the BDMV main folder 210, and (ii) other image data except the image data equivalent to image having the frame rate of 30 fps, in or below the HIGHRATE main folder 220.

On the other hand, when the capturing mode is the normal capturing mode (No at S100), then the imaging unit 102 images light received via the lens group 101 (S111). The imaging unit 102 converts signals of the received light to analog signals. The A/D conversion unit 103 converts the analog signals to digital signals.

Next, the image signal processing unit 104 performs image signal processing, such as noise cancellation and image quality adjustment, on the digital signals provided from the A/D conversion unit 103 in order to generate image signals (signal 60i) (S112).

Next, the first compression multiplex unit 105 compresses and multiplexes the signal 60i generated by the image signal processing unit 104 to generate data of a normal content in conformity to the conventional standard (S113).

Next, the recording unit 106 records the normal content generated by the first compression multiplex unit 105 to the BDMV main folder 210 in the recording medium 200 (S114).

As described above, at the normal capturing mode, the image recording/reproducing device 100 records image data equivalent to image having a frame rate of 30 fps in conformity to the conventional standard, in or below the BDMV main folder 210.

Here, the above-described processing performed by the image signal processing unit 104, the first compression multiplex unit 105, the second compression multiplex unit 107, and the recording unit 106 are controlled by the control unit 110. Moreover, a disk position and the like in recording data from the recording unit 106 to the recording medium 200 is controlled by the recording control unit 108.

Next, the reproduction processing performed by the image recording/reproducing device 100 is described.

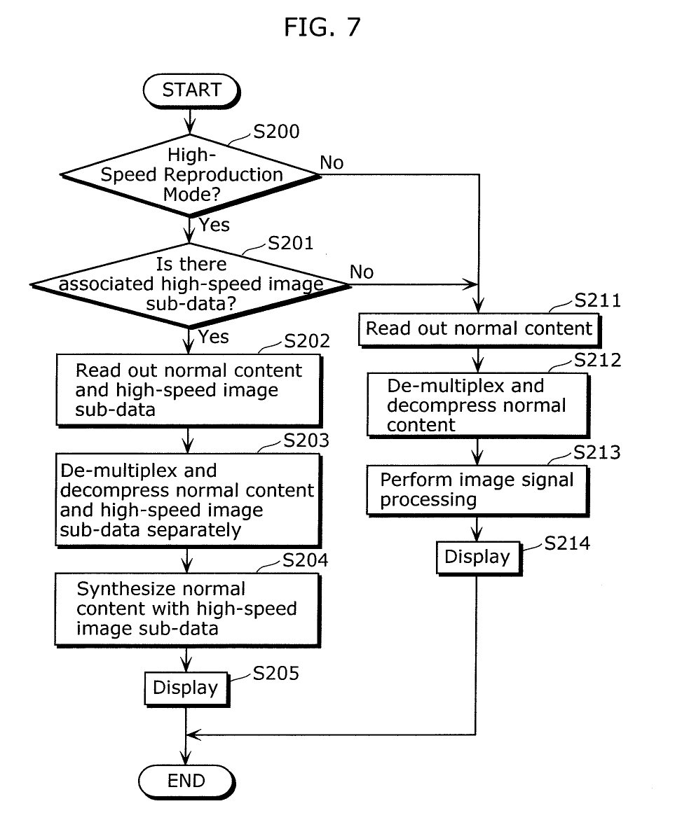

FIG. 7 is a flowchart of the reproduction processing performed by the image recording/reproducing device 100.

Firstly, the control unit 110 checks a reproduction mode set by the user via the input unit 109 (S200).

When the reproduction mode is the normal reproduction mode (No at S200), then the reproduction unit 115 reads out the normal content to be reproduced from the recording medium 200 (S211).

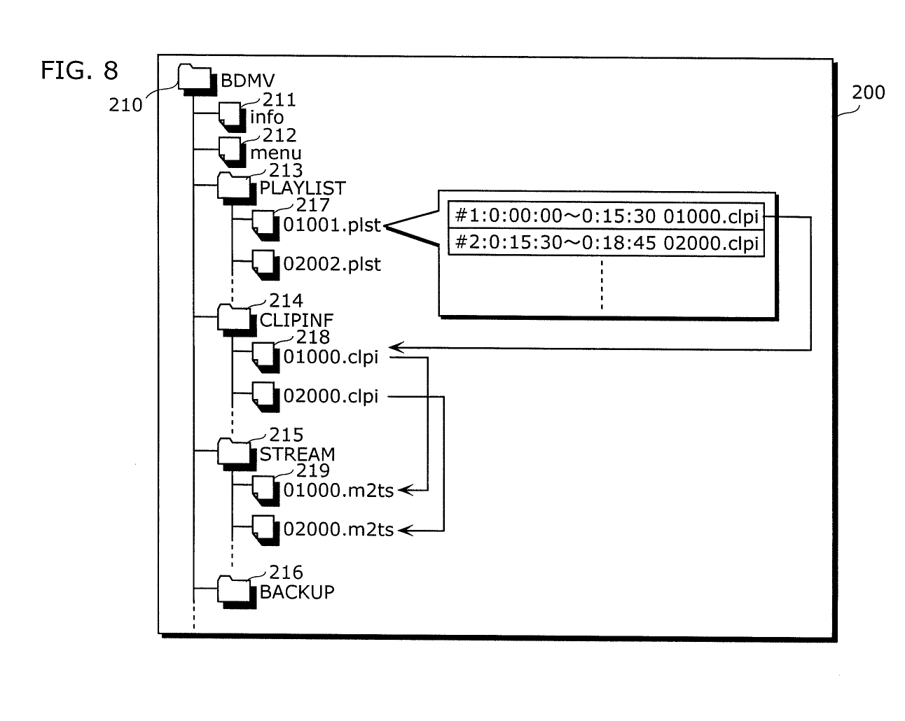

FIG. 8 is an example for explaining relationships among files in and below the BDMV main folder 210 in the file structure of FIG. 6.

At the normal reproduction mode, the control unit 110 uses three kinds of files, which are the playlist file 217, the clipinfo file 218, and the stream file 219, in order to control reproduction.

The playlist file 217 includes (i) information for designating clipinfo files 218 and (ii) reproduction time information. The reproduction unit 115 sequentially refers to the clipinfo files 218 indicated in the playlist file 217 to be reproduced. The reproduction unit 115 reads out a corresponding stream file 219 designated in the time table in each of the clipinfo files 218.

For example, the playlist file 217 (01001.plst) includes a clip (#1) and a clip (#2), and indicates that reproduction is performed in an order of the clip (#1) and then the clip (#2). For the clip (#1), the reproduction unit 115 reads out a stream file 219 (01000.m2ts) in association with a clipinfo file 218 (01000.clpi). For the clip (#2), the reproduction unit 115 reads out a stream file 219 (02000.m2ts) in association with a clipinfo file 218 (02000.clpi).

The first de-multiplex decompression unit 114 de-multiplexes and decompresses the normal content read out by the reproduction unit 115 (S212).

The image signal processing unit 113 performs processing, such as image quality adjustment for displaying, on the decompressed normal content provided from the first de-multiplex decompression unit 114, thereby generating normal reproduction image (S213).

The display unit 112 reproduces the normal reproduction image generated by the image signal processing unit 113 to display the reproduced image on a monitor or the like (S214).

As described above, at the normal capturing mode, the image recording/reproducing device 100 reads out image data equivalent to image having a frame rate of 30 fps in conformity to the conventional standard from the BDMV main folder 210 and reproduces the read-out image data.

Here, the file structure in the BDMV main folder 210 is the same as folder structures of the conventional standard. Thereby, even if the image reproducing devices in conformity to the conventional standard which does not support reproduction of high-speed captured image reproduce the recording medium 200, the image reproducing devices can reproduce image equivalent to image having a frame rate of 30 fps. In addition, the image reproducing devices in conformity to the conventional standard can also use other conventional functions such as playlist editing.

On the other hand, when the reproduction mode is the high-speed reproduction mode (Yes at S200), the control unit 110 determines whether or not high-speed image sub-data in association with the normal content to be reproduced is recorded in the recording medium 200 (S201).

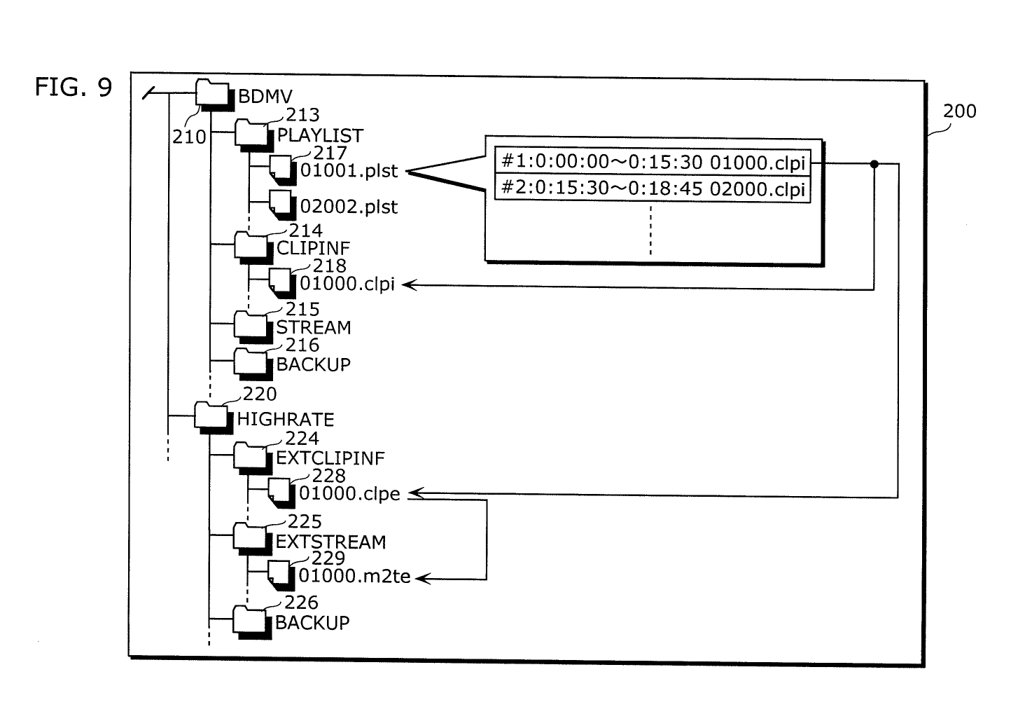

FIG. 9 is an example for explaining relationships among files in and below the BDMV main folder 210 and files in and below the HIGHRATE main folder 220 in the file structure of FIG. 6.

At the high-speed reproduction mode, the control unit 110 refers to the playlist file 217 in the BDMV main folder 210. Based on the playlist file 217, the control unit 110 refers to the clipinfo file 218 below the BDMV main folder 210 and the clipinfo file 228 below the HIGHRATE main folder 220.

At the high-speed capturing mode, to the HIGHRATE main folder 220 the recording unit 106 records high-speed image sub-data in association with a clip of a normal content. Here, according to a file naming rule for specifying a one-to-one relationship between files using their file names, the recording unit 106 assigns a file name to (i) the clipinfo file 218 associated with the stream file 219 regarding the normal content and (ii) the clipinfo file 228 associated with the stream file 229 regarding the high-speed image sub-data. In other words, the recording unit 106 assigns a file name to a file in which a normal content is recorded and to a file in which high-speed image sub-data is recorded, in order to specify one-to-one relationship between the files.

In the first embodiment, each of the clipinfo file 218 and the clipinfo file 228 regarding the normal content and the high-speed image sub-data, respectively, which are generated from image captured during the same time period and recorded, is assigned with the same 5-digit numerals (01000) as a file name.

Moreover, the recording unit 106 generates the stream file 219 and the stream file 229 so that frames of the high-speed image sub-data which are captured during a time period between a time of capturing a frame in the normal content and a time of capturing a next frame subsequent to the frame in the normal content are always associated with the frame in the normal content to be treated together as a set. In other words, on the recording medium 200 the recording unit 106 records the normal content and the high-speed image sub-data so that a part of the normal content and a part of the high-speed image sub-data, which are generated from image captured during the same time period of the first time unit, are recorded in association with each other. Here, during one unit of the first time unit, (i) one frame to be in the normal content and (ii) one or more frames to be in the high-speed image sub-data are captured, and eventually recorded in association with each other. For example, in the example of FIG. 5, during one unit of the first time unit, (i) one frame to be in the normal content and (ii) four frames to be in the high-speed image sub-data captured until capturing of a next frame to be in the normal content are captured and eventually recorded in association with each other.

More specifically, when the recording unit 106 records the first to second frames of the normal content to the recording medium 200, if a frame subsequent to the second frame in the signal 60i is the third frame, the recording unit 106 records, as a part of the high-speed image sub-data associated with the recorded frames of the normal content, frames in the signal 300i ranging from a frame immediately after a timing of capturing the first frame of the signal 60i to a frame immediately prior to a timing of the third frame of the signal 60i.

For instance, in FIG. 5, a frame 0 of the normal content is always associated with frames 1, 2, 3, and 4 of the high-speed image sub-data, as one set. For example, when a recording start point is designated as the frame 0 and a recording end point is designated as a frame 10 in the normal content, recording of the high-speed image sub-data is performed from the frame 1 belonging to the same set as the frame 0 of the normal content to a frame 14 belonging to the same set as the frame 10 of the normal content.

The reproduction unit 115 firstly reproduces the clip (#1) with reference to the playlist file 217 regarding the normal content. In addition to referring to the clipinfo file 218 (01000.clpi) of the normal content designated by the clip (#1), the control unit 110 detects that there is high-speed image sub-data associated with the clipinfo file 218 (01000.clpi), using the file name (01000) of the clipinfo file 228 associated with the clipinfo folder 224 (EXTCLIPINF).

Here, since there is the clipinfo file 228 having the same file name (01000) as the file name of the clipinfo file 218 (in other words, high-speed image sub-data associated with the clip (#1) is recorded) (Yes at S201), then the normal content to be reproduced (namely, the clip (#1)) and the high-speed image sub-data associated with the normal content are read out from the recording medium 200 (S202).

In more detail, the reproduction unit 115 reads out the stream file 229 (01000.m2te) regarding the high-speed image sub-data which is associated with the clipinfo file 228 (01000.clpe). In addition, the reproduction unit 115 reads out the stream file 219 (01000.m2ts) regarding the normal content which is associated with the clipinfo file 218 (01000.clpi).

Next, the first de-multiplex decompression unit 114 de-multiplexes and decompresses the normal content read out by the reproduction unit 115, and the second de-multiplex decompression unit 116 de-multiplexes and decompresses the high-speed image sub-data read out by the reproduction unit 115 (S203).

Then, the image signal processing unit 113 synthesizes the decompressed normal content and the decompressed high-speed image sub-data together to reconstruct image signals having a frame rate of 300 fields per second. The image signal processing unit 113 generates smooth slow playback image from the reconstructed image signals having the frame rate of 300 fields per second (S204).

The display unit 112 reproduces the slow playback image generated by the image signal processing unit 113 and displays the reproduced image on a monitor or the like (S205).

As described above, at the high-speed reproduction mode, the image recording/reproducing device 100 controls reproduction of (i) the normal content and (ii) the high-speed image sub-data associated with the normal content, using information of the reproduction procedure included in the playlist file 217. The image recording/reproducing device 100 reads out image data equivalent to image having a frame rate of 30 fps in conformity to the conventional standard from the BDMV main folder 210, and also reads out the high-speed image sub-data from the HIGHRATE main folder 220. The image recording/reproducing device 100 reconstructs and reproduces high-speed image, using the readout image data equivalent to image having a frame rate of 30 fps and the readout high-speed image sub-data.

On the other hand, if there is no clipinfo file 228 having the same file name as the file name of the clipinfo file 218 designated by the playlist file 217 (in other words, the image to be reproduced is normal captured image and high-speed image sub-data associated with the normal captured image is not recorded) (No at S201), then the image recording/reproducing device 100 performs the same processing as the processing at the normal reproduction mode (S211 to S214). It should be noted that, if such associated high-speed image sub-data is not recorded on the recording medium 200 (No at S201), then the control unit 110 may display detail of the error or the like to the user and complete the reproduction processing. Or, the image recording/reproducing device 100 may perform slow playback for the normal content at normal frame intervals.

Here, the above-described processing performed by the reproduction unit 115, the first de-multiplex decompression unit 114, the second de-multiplex decompression unit 116, and the image signal processing unit 113 are controlled by the control unit 110.

By the above procedure, in order to perform high-speed reproduction of the clip (#1), the image recording/reproducing device 100 reconstructs consecutive high-speed captured image using (i) the normal content obtained by reproducing the stream file 219 (01000.m2ts) associated with the clipinfo file 218 (01000.clpi) and (ii) the high-speed image sub-data obtained by reproducing the stream file 229 (01000.m2te) associated with the clipinfo file 228 (01000.clpe), and then performs smooth slow playback of the reconstructed image.

Here, if the playlist file 217 indicates the frame 10 of the normal content in FIG. 5 as a reproduction end point (namely, an OUT point) of the clip (#1), the control unit 110 uses frames up to the frame 14 of the high-speed image sub-data in FIG. 5, as high-speed image sub-data associated with the normal content.

Then, the control unit 110 starts controlling reproduction of the next clip (#2).

Here, if the playlist file 217 is edited to indicate the frame 5 of the normal content in FIG. 5 as the OUT point, the control unit 110 uses frames up to the frame 9 of the high-speed image sub-data in FIG. 5 as high-speed image sub-data associated with the normal content. Then, the control unit 110 starts controlling reproduction of the next clip (#2).

In other words, when the first to second frames of the normal content are reproduced, if a frame subsequent to the second frame in the signal 60i is the third frame, the control unit 110 controls to reproduce the high-speed image sub-data of the signal 300i from a frame immediately after a timing of capturing the first frame of the signal 60i to a frame immediately prior to a timing of capturing the third frame of the signal 60i.

Here, when the control unit 110 controls a reproduction range, the control unit 110 controls, for example, a data range of the stream file 229 readout by the reproduction unit 115. It should be noted that the control unit 110 may control a data range that is de-multiplexed and decompressed by the second de-multiplex decompression unit 116, or may control a data range displayed by the display unit 112 by controlling a data range synthesized by the image signal processing unit 113.

As described above, the file naming rule is predetermined to specify a one-to-one relationship between the clipinfo file 218 regarding the normal content and the clipinfo file 228 regarding the high-speed image sub-data using their file names. Then, the frames 1 to 4 of the high-speed image sub-data captured during a time period between a time of capturing the frame 0 of the normal content and a time of capturing the frame 5 subsequent to the frame 0 of the normal content are always associated with the frame 0 of the normal content as a set. Thereby, by controlling generation of the stream files 219 and 229 and playlist reproduction, the playlist file 217 regarding the normal content can be used also for controlling reproduction of the high-speed image sub-data. In short, the reproduction of the normal content and the high-speed captured image can be performed easily using only the playlist file 217 below the BDMV main folder 210.

Moreover, when a capturing mode is switched to another capturing mode, the recording unit 106 records (i) a normal content generated at the capturing mode applied before the switching and (ii) a normal content generated at the capturing mode applied after the switching, to respective different files separately.

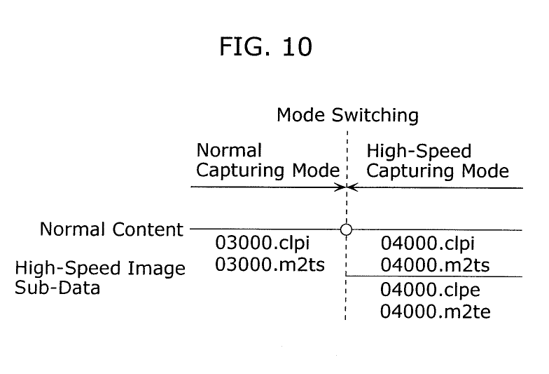

FIG. 10 is a diagram showing relationships among files recorded in switching a capturing mode to another capturing mode.

As shown in FIG. 10, when a capturing mode is switched from the normal capturing mode to the high-speed capturing mode during capturing image, the recording unit 106 generates 03000.clpi as a clipinfo file 218 and 03000.m2ts as a stream file 219 which are regarding a normal content captured at the normal capturing mode.

On the other hand, the recording unit 106 generates 04000.clpi as a clipinfo file 218 and 04000.m2ts as a stream file 219 which are regarding a normal content captured at the high-speed capturing mode. The recording unit 106 also generates 04000.clpe as a clipinfo file 228 and 04000.m2te as a stream file 229 which are regarding high-speed image sub-data captured at the high-speed capturing mode associated with the normal content captured at the high-speed capturing mode.

Thereby, even if a capturing mode is switched to another capturing mode during capturing image, a file of the normal content captured at the high-speed capturing mode is associated with a file of the high-speed image sub-data. As a result, using the playlist file 217 specifying a procedure for reproducing the normal content, the procedure for reproducing the high-speed image sub-data can be easily managed.

Also when a capturing mode is switching from the high-speed capturing mode to the normal capturing mode, in the same manner as the processing in switching to the high-speed capturing mode, the recording unit 106 separately generates (i) a clipinfo file 218 and a stream file 219 regarding a normal content captured at the high-speed capturing mode and (ii) a clipinfo file 218 and a stream file 219 regarding a normal content captured at the normal capturing mode.

Here, the capturing mode switching is performed by the control unit 110 according to user's operation inputted using the input unit 109.

As described above, the image recording/reproducing device 100 according to the first embodiment of the present invention can record image captured at a high speed to the recording medium 200 and then perform smooth slow playback of the captured image.

In addition, when the recording medium 200 recorded by the image recording/reproducing device 100 is inserted to and reproduced by image reproducing devices in conformity to the conventional standard that does not support reproduction of high-speed captured image, the image reproducing devices can reproduce image equivalent to image having a frame rate of 30 fps with reference to the BDMV main folder 210. Moreover, the image reproducing devices can reproduce image for which screen reduction and screen division multiplexing are not performed. That is, the image recording/reproducing device 100 can ensure compatibility with image reproducing devices having conventional standards.

In addition, the image recording/reproducing device 100 generates the playlist file 217 only in the BDMV main folder 210. Here, the playlist file 217 has a format in conformity to the conventional standard. Thereby, playlist editing can be performed by image reproducing devices in conformity to the conventional standard that does not support reproduction of high-speed captured image. Furthermore, even if on a recording medium a playlist is edited by such an image reproducing device in conformity to the conventional standard and the recording medium is inserted to the image recording/reproducing device 100 to be reproduced, it is possible to perform smooth slow playback of image by the procedure according to the edited playlist.

Furthermore, the image recording/reproducing device 100 records both of (i) image data in conformity to the conventional standard and (ii) high-speed image sub-data, to a single file system in the recording medium 200. Thereby, the high-speed captured image recorded by the image recording/reproducing device 100 can be managed more easily than high-speed captured image which is divided into image data in conformity to a conventional standard and high-speed image sub-data to be recorded in respective different recording mediums. That is, the image recording/reproducing device 100 can record high-speed captured image to be easily managed.

Still further, if the HIGHRATE main folder 220 has the same backup folder 226 as that in the BDMV main folder 210, the file operation procedure for operating the backup folders during editing processing can be shared between the processing for a normal content and the processing for high-speed image sub-data.

Although the image recording/reproducing device 100 according to the first embodiment of the present invention has been described as above, the present invention is not limited to the above.

It should be noted that it has been described in the above explanation that a single main folder regarding normal contents is associated with a single main folder regarding high-speed image sub-data, but the high-speed image sub-data may be divided into plural pieces which are recorded in respective different main folders.

It should also be noted that it has been described in the above explanation that image in conformity to a conventional standard has a frame rate of 30 fps, but image in conformity to a conventional standard may have any other frame rate except the frame rate of 30 fps. For example, image in conformity to a conventional standard may have a frame rate of 60 fps.

It should also be noted that it has been described in the above explanation that the high-speed captured image has a frame rate of 300 fields per second, but the frame rate of the high-speed captured image is not limited to the above and may be any frame rate higher than the frame rate of the conventional standard.

It should also be noted that it has been described in the above explanation that in FIG. 7 the image recording/reproducing device 100 determines whether or not a reproduction mode is the high-speed reproduction mode (S200) and then determines whether or not the high-speed image sub-data exists (S201), but it is also possible that the image recording/reproducing device 100 firstly determines whether or not the high-speed image sub-data exists (S201) and then determines whether or not a reproduction mode is the high-speed reproduction mode (S200). Furthermore, the image recording/reproducing device 100 may perform the determination as to whether or not a reproduction mode is the high-speed reproduction mode (S200) per a predetermined time period.

It should also be noted that the folder structure shown in FIG. 6 is used in the above explanation, but the present invention is not limited to the above as far as (i) image equivalent to image having a frame rate of 30 fps and (i) the other image are stored in respective different folders. In other words, the present invention is not limited as far as the playlist file 217, the clipinfo file 218, and the stream file 219 are recorded in the BDMV main folder 210 or in folders below the BDMV main folder 210 in a hierarchical structure. In other words, the present invention is not limited as far as the clipinfo file 218 and the stream file 219 are recorded in the HIGHRATE main folder 220 or in folders below the HIGHRATE main folder 220 in a hierarchical structure.

It should also be noted that substance of the information included in each of the playlist file 217, the clipinfo file 218, and the stream file 219 is not necessarily stored in the BDMV main folder 210. It is also possible that only information for specifying the substance of the information included in each of the playlist file 217, the clipinfo file 218, and the stream file 219 is stored in the BDMV main folder 210. In other words, the present invention is not limited as far as the playlist file 217, the clipinfo file 218, and the stream file 219 are recorded in association with the BDMV main folder 210.

Likewise, substance of the information included in each of the clipinfo file 228 and the stream file 229 are not necessarily stored in the HIGHRATE main folder 220. It is also possible that only information for specifying the substance of the information included in each of the clipinfo file 228 and the stream file 229 is stored in the HIGHRATE main folder 220. In other words, the present invention is not limited as far as the clipinfo file 228 and the stream file 229 are recorded in association with the HIGHRATE main folder 220.

It should also be noted that it has been described that the clipinfo files 218 and 219 have the same file names, but the file names may be anything as far as the relationship between the files can be specified. For example, a part of each of the file names may be the same.

### Second Embodiment

An image recording/reproducing device according to a second embodiment of the present invention is a modification of the image recording/reproducing device 100 according to the first embodiment. In the second embodiment of the present invention, the image recording/reproducing device can support recording and reproduction of high-resolution image, keeping the characteristics of the present invention in ensuring compatibility with image reproducing devices having conventional standards and recording image to be easily managed.

The image recording/reproducing device 100 according to the second embodiment can switch between (i) a normal capturing mode for capturing an object at a normal resolution and (ii) a high-resolution capturing mode for capturing an object at a high resolution that is higher than the normal resolution. Further, the image recording/reproducing device 100 according to the second embodiment can switch between (i) a normal reproduction mode for reproducing, at the normal resolution, the image data captured at the high-resolution capturing mode and (ii) a high-resolution reproduction mode for reproducing, at the high resolution, the image data captured at the high-resolution capturing mode. Furthermore, the image recording/reproducing device 100 can reproduce, at the normal resolution, the image data captured at the normal capturing mode. For example, the normal resolution is 1920×1080 pixels and the high resolution is 4096×2160 pixels or 3840×2160 pixels.

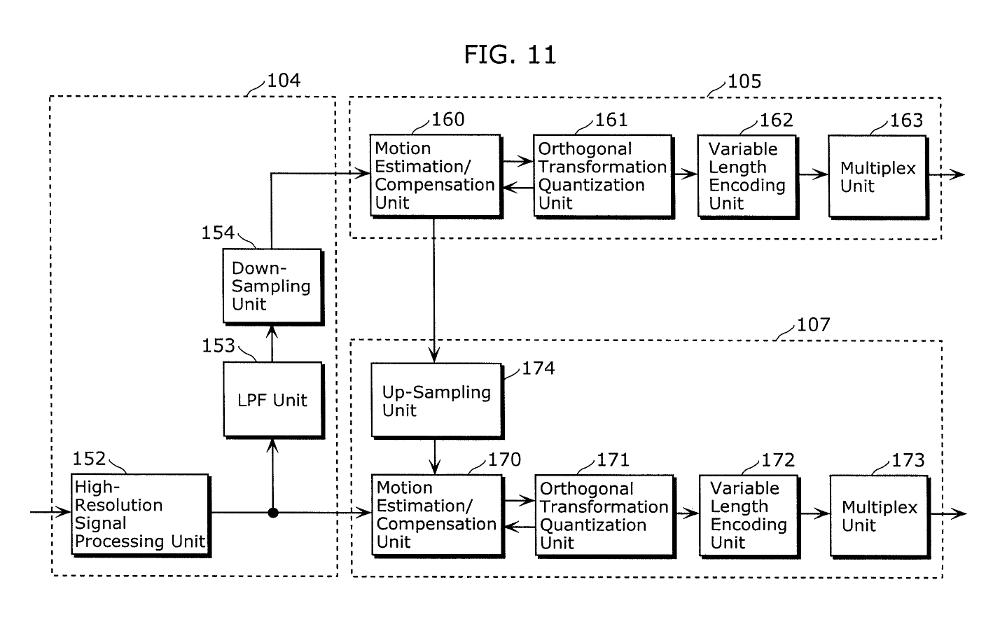

FIG. 11 is a block diagram showing structures of the image signal processing unit 104, the first compression multiplex unit 105, and the second compression multiplex unit 107 according to the second embodiment of the present invention.

The image signal processing unit 104 performs image signal processing on the digital signals provided from the A/D conversion unit 103 to generate normal-resolution image signals having the normal resolution and high-resolution image signals having the high resolution.

At the normal capturing mode, the image signal processing unit 104 performs image signal processing on the digital signals to generate the normal-resolution image signals and provides the generated signals to the first compression multiplex unit 105.

At the high-resolution capturing mode, the image signal processing unit 104 performs image signal processing on the digital signals to generate the high-resolution image signals and provides the generated signals to the second compression multiplex unit 107. In addition, the image signal processing unit 104 converts a resolution of the generated high-resolution image signals to the normal resolution in order to generate normal-resolution image signals, and provides the generated signals to the first compression multiplex unit 105.

The image signal processing unit 104 includes a high-resolution signal processing unit 152, a LPF unit 153, and a down-sampling unit 154.

The high-resolution signal processing unit 152 performs image signal processing, such as noise cancellation and image quality adjustment, on the digital signals provided from the A/D conversion unit 103 to generate high-resolution image signals, and provides the generated image signals to the second compression multiplex unit 107 and the LPF unit 153.

The LPF unit 153 performs low-pass filtering on the high-resolution image signals, and provides the resulting high-resolution image signals to the down-sampling unit 154.

The down-sampling unit 154 performs sub-sampling on the high-resolution image signals provided from the LPF unit 153 to generate normal-resolution image signals, and provides the resulting normal-resolution image signals to the first compression multiplex unit 105.

Using a coding method such as MPEG-2 or H.264, the first compression multiplex unit 105 compresses and multiplexes the normal-resolution image signals provided from the image signal processing unit 104. The first compression multiplex unit 105 provides, as a normal content, the generated compressed image data to the recording unit 106.

The first compression multiplex unit 105 includes the motion estimation/compensation unit 160, the orthogonal transformation quantization unit 161, the variable length encoding unit 162, and the multiplex unit 163.

The motion estimation/compensation unit 160 generates a prediction image using a result of motion estimation and reference image(s). The motion estimation/compensation unit 160 generates a prediction error that is a difference between (i) the generated prediction image and (ii) the normal-resolution image signals provided from the image signal processing unit 104, and provides the generated prediction error to the orthogonal transformation quantization unit 161.

In addition, the motion estimation/compensation unit 160 generates a reference image using the prediction error generated by the orthogonal transformation quantization unit 161, and provides the generated reference image to the up-sampling unit 174.

It should be noted that the structures of the orthogonal transformation quantization unit 161, the variable length encoding unit 162, and the multiplex unit 163 are the same as the structures described in the first embodiment.

Using a coding method such as MPEG-2 or H.264, the second compression multiplex unit 107 compresses and multiplexes the high-resolution image signals provided from the image signal processing unit 104. The second compression multiplex unit 107 provides, as high-resolution data, the resulting compressed image data to the recording unit 106.

Using the reference image provided from the first compression multiplex unit 105, the second compression multiplex unit 107 performs layered coding on the high-resolution image signals provided from the image signal processing unit 104.

The second compression multiplex unit 107 includes the motion estimation/compensation unit 170, the orthogonal transformation quantization unit 171, the variable length encoding unit 172, the multiplex unit 173, and an up-sampling unit 174.

The up-sampling unit 174 up-samples the reference image provided from the motion estimation/compensation unit 160 to generate inter-layer prediction reference image having the high resolution, and provides the generated inter-layer prediction reference image to the motion estimation/compensation unit 170. If necessary, the first compression multiplex unit 105 provides also a compression processing parameter used in the first compression multiplex unit 105 to the motion estimation/compensation unit 170 via the up-sampling unit 174. Here, the compression processing parameter is a result of motion estimation of the motion estimation/compensation unit 160, for example.

The motion estimation/compensation unit 170 generates a prediction image using a result of motion estimation and the reference image(s). Here, the motion estimation/compensation unit 170 performs layered coding using (i) the result of the motion estimation estimated from the high-resolution image signals, (ii) the inter-layer prediction reference image provided from the up-sampling unit 174, and (iii) the compression processing parameter used in the first compression multiplex unit 105.

The motion estimation/compensation unit 170 generates a prediction error that is a difference between (i) the generated prediction image and (ii) the high-resolution image signals provided from the image signal processing unit 104, and provides the generated prediction error to the orthogonal transformation quantization unit 171.

Here, the first compression multiplex unit 105 generates a normal content including the first compression information used in the compression and multiplexing of the first compression multiplex unit 105. The first compression information includes the above-described reference image, compression processing parameter, and the like.

Since the second compression multiplex unit 107 performs the compression and multiplexing processing using the first compression information provided from the first compression multiplex unit 105, the high-resolution data including the second compression information may not include a portion equivalent to the first compression information used in the compression and multiplexing processing of the second compression multiplex unit 107.

In other words, the first compression information is a portion of image information included in the high-resolution image signals, and also a portion of image information included in the normal-resolution image signals. This means that the second compression multiplex unit 107 generates the high-resolution data by compressing a remaining portion except at least the above-mentioned portion of the image information included in the normal-resolution image signals from among the image information included in the high-resolution image signals.

It should be noted that the structures of the orthogonal transformation quantization unit 171, the variable length encoding unit 172, and the multiplex unit 173 are the same as the structures described in the first embodiment.

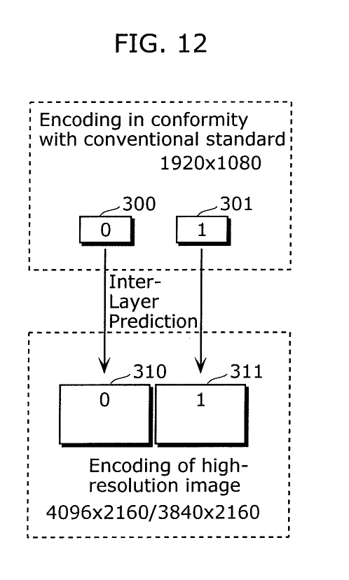

FIG. 12 is a diagram showing processing performed by the first compression multiplex unit 105 and the second compression multiplex unit 107 for generating prediction image.

For example, the image signal processing unit 104 generates normal-resolution image signals 300 from the high-resolution image signals 310. Here, using reference image and compression processing parameter which are obtained by compressing the normal-resolution image signals 300, the first compression multiplex unit 105 generates prediction image of the high-resolution image signals to be used by the second compression multiplex unit 107.

The recording unit 106 records (i) the normal content generated by the first compression multiplex unit 105 and (ii) the high-resolution data generated by the second compression multiplex unit 107, to respective different folders in a recording medium 200.

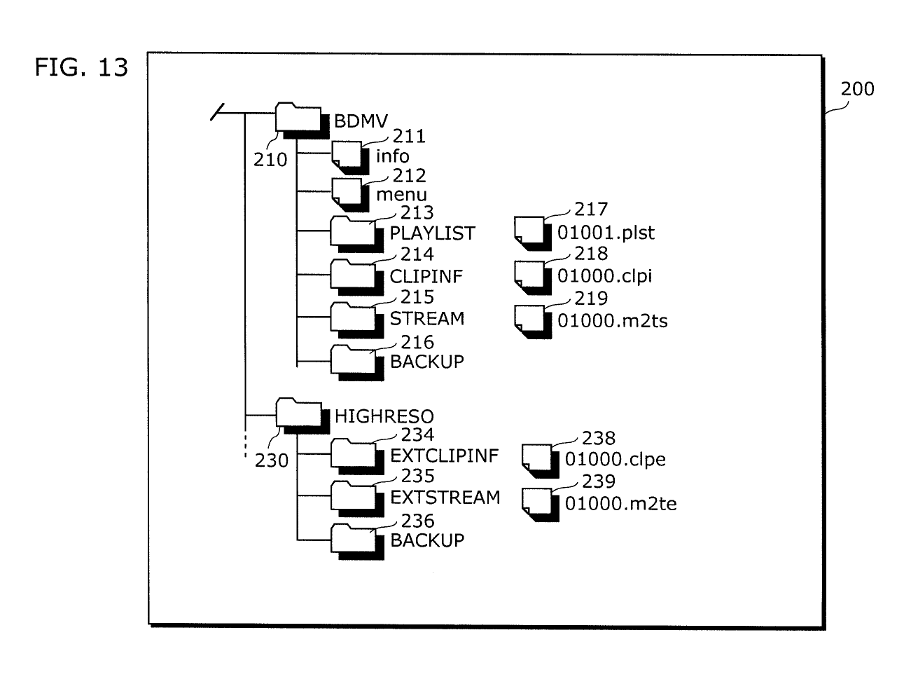

FIG. 13 is a diagram showing an example of a file structure of files recorded in the recording medium 200 according to the second embodiment of the present invention.

As shown in FIG. 13, in a file system for files recorded in the recording medium 200 there are a BDMV main folder 210 and a HIGHRESO main folder 230 in a highest hierarchy layer of a directory structure.

The BDMV main folder 210 is a folder for compatibility with a conventional standard. In the BDMV main folder 210, normal contents are recorded in a recording format in conformity to the conventional standard. On the other hand, the HIGHRESO main folder 230 is a folder for high-resolution captured image. In the HIGHRESO main folder 230, the high-resolution data recorded in a unique recording format.

Below the BDMV main folder 210, there are an information file 211 (info), a menu file 212 (menu), a playlist folder 213 (PLAYLIST), clipinfo folder 214 (CLIPINF), a stream folder 215 (STREAM), and a backup folder 216 (BACKUP).

The information file 211 (info) includes management information for managing the entire directory. The menu file 212 (menu) includes information for structuring a menu.

Below the playlist folder 212 (PLAYLIST), a playlist file 217 (01001.plst) is stored. The playlist file 217 (01001.plst) includes information for reproducing normal contents. In more detail, the playlist file 217 has information regarding an order of reproducing normal contents. In addition, the playlist file 217 includes (i) information for designating clipinfo files 218 and (ii) reproduction time information.

Below the clipinfo folder 214 (CLIPINF), a clipinfo file 218 (01000.clpi) is stored. The clipinfo file 218 (01000.clpi) includes information for reproducing a normal content. In more detail, the clipinfo file 218 indicates a relationship between time information and a position of image data (a stream file 219). Further, the clipinfo file 218 includes a time table for achieving partial playback and special playback of the corresponding image data. Furthermore, the clipinfo file 218 includes information regarding the corresponding image data, such as an image size and a compression method.

Below the stream folder 215 (STREAM), a stream file 219 (01000.m2ts) is stored. The stream file 219 (01000.m2ts) is an audio-visual (AV) data file.

The backup folder 216 (BACKUP) holds copies of the information file 211 (info), the menu file 212 (menu), the playlist folder 213 (PLAYLIST), and the clipinfo folder 214 (CLIPINF), which are currently being edited. Thereby, it is possible to prevent that normal contents cannot be reproduced due to power discontinuity or the like in the middle of the editing.

Below the HIGHRESO main folder 230, there are a clipinfo folder 234 (EXTCLIPINF), a stream folder 235 (EXTSTREAM), and a backup folder 236 (BACKUP).

Below the clipinfo folder 234 (EXTCLIPINF), a clipinfo file 238 (01000.clpe) is stored. The clipinfo file 238 (01000.clpe) includes information for reproducing high-resolution data. In more detail, the clipinfo file 238 indicates a relationship between time information and a position of image data (a stream file 239). In addition, the clipinfo file 238 includes a time table for achieving partial playback and special playback of the corresponding image data. Furthermore, the clipinfo file 238 includes information regarding the corresponding image data, such as an image size and a compression method.

Below the stream folder 235 (EXTSTREAM), a stream file 239 (01000.m2te) is stored. The stream file 239 (01000.m2te) is a file of high-speed image sub-data.

The backup folder 236 (BACKUP) holds a copy of the clipinfo folder 234 (EXTCLIPINF) which is, for example, currently being edited.

Here, below the HIGHRESO main folder 230, there is neither a folder corresponding to the playlist folder 213 nor a folder corresponding to a playlist file 217. In other words, the control unit 110 does not control the recording unit 106 to record, below the HIGHRESO main folder 230, a playlist that includes information indicating a procedure for reproducing high-resolution data and high-resolution captured image.

As described above, at the high-resolution capturing mode, the image recording/reproducing device 100 according to the second embodiment records (i) a normal content having a resolution of 1920×1080 pixels in conformity to a conventional standard, in or below the BDMV main folder 210, and (ii) high-resolution data having a resolution of 4096×2160 pixels or 3840×2160 pixels which is higher than a resolution of the conventional standard, in or below the HIGHRESO main folder 230.

The processing performed when the capturing mode is the normal capturing mode is the same as the processing described in the first embodiment, so that description of the processing is not repeated.

The above-described processing performed by the image signal processing unit 104, the first compression multiplex unit 105, the second compression multiplex unit 107, and the recording unit 106 are controlled by the control unit 110. Moreover, a disk position and the like in recording data from the recording unit 106 to the recording medium 200 is controlled by the recording control unit 108.

Next, the reproduction processing performed by the image recording/reproducing device 100 according to the second embodiment is described.

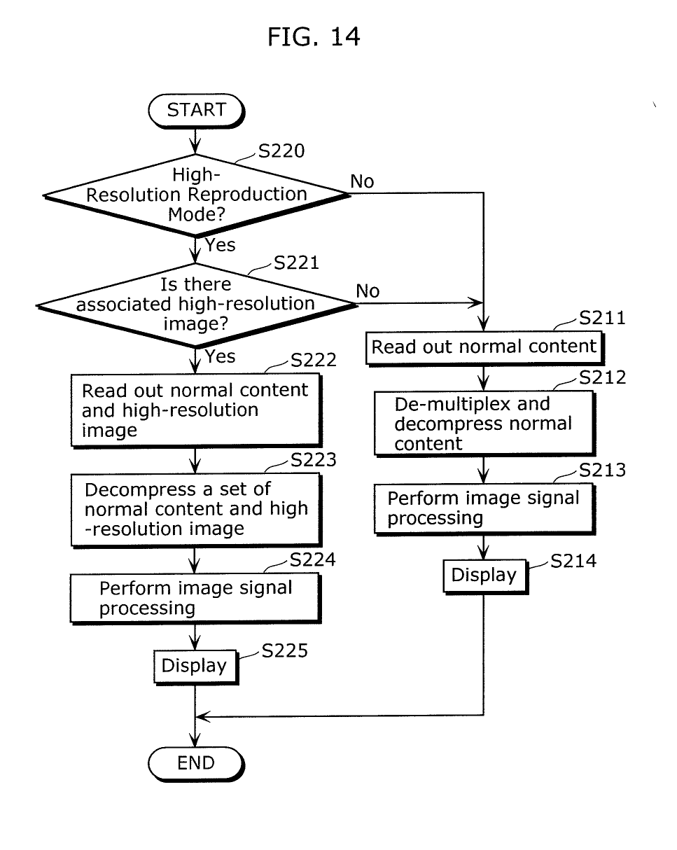

FIG. 14 is a flowchart of the reproduction processing performed by the image recording/reproducing device 100 according to the second embodiment.

Firstly, the control unit 110 checks a reproduction mode set by a user via the input unit 109 (S220).

The processing performed when the reproduction mode is the normal reproduction mode (No at S220) is the same as the processing described in the first embodiment, so that description of the processing is not repeated. Here, as described in the first embodiment, the file structure in the BDMV main folder 210 is the same as folder structures of the conventional standard. Thereby, even if the image reproducing devices in conformity to the conventional standard which does not support reproduction of high-resolution image reproduce the recording medium 200, the image reproducing devices can reproduce image having a resolution of 1920×1080 pixels. In addition, the image reproducing devices in conformity to the conventional standard can also use other conventional functions such as playlist editing.

On the other hand, when the reproduction mode is the high-resolution reproduction mode (Yes at S220), the control unit 110 determines whether or not high-resolution data in association with the normal content to be reproduced is recorded in the recording medium 200 (S221).

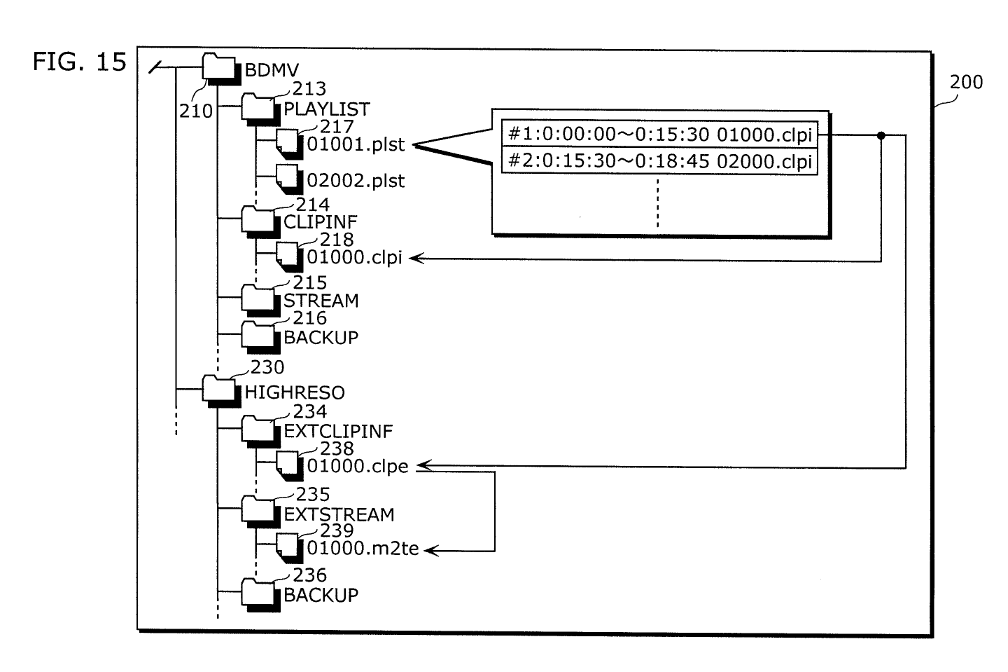

FIG. 15 is a diagram for explaining relationships among files in and below the BDMV main folder 210 and files in and below a HIGHRESO main folder 230 in the file structure of FIG. 13.

For reproduction at the high-resolution reproduction mode, based on the playlist file 217, the control unit 110 refers to the clipinfo file 218 below the BDMV main folder 210 and the clipinfo file 238 below the HIGHRESO main folder 230.

For recording at the high-resolution capturing mode, to the HIGHRESO main folder 230 the recording unit 106 records high-resolution data in association with a clip of a normal content. Here, according to a file naming rule for specifying a one-to-one relationship between files using their file names, the recording unit 106 assigns a file name to (i) the clipinfo file 218 associated with the stream file 219 regarding the normal content and (ii) the clipinfo file 238 associated with the stream file 239 regarding the high-resolution data. In other words, the recording unit 106 assigns a file name to a file in which a normal content is recorded and to a file in which high-resolution data is recorded, in order to specify one-to-one relationship between the files.

In the second embodiment, each of the clipinfo file 218 and the clipinfo file 238 regarding the normal content and the high-resolution data, respectively, which are captured during the same time period and recorded is assigned with the same 5-digit numerals (01000) as a file name.

Moreover, the recording unit 106 generates the stream file 219 and the stream file 239 so that the normal content and the high-resolution data which are captured during the same time period are always associated with each other to be treated together as a set. In other words, on the recording medium 200 the recording unit 106 records the normal content and the high-resolution data so that a part of the normal content and a part of the high-resolution data, which are generated from image captured during the same time period, are recorded in association with each other.

The reproduction unit 115 firstly reproduces the clip (#1) with reference to the playlist file 217 regarding the normal content. In addition to referring to the clipinfo file 218 (01000.clpi) of the normal content designated by the clip (#1), the control unit 110 detects that there is high-resolution data associated with the clipinfo file 218 (01000.clpi), using the file name (01000) of the clipinfo file 238 associated with the clipinfo folder 234 (EXTCLIPINF).

Here, since there is the clipinfo file 238 having the same file name (01000) as the file name of the clipinfo file 218 (in other words, high-resolution data associated with the clip (#1) is recorded) (Yes at S221), then the normal content to be reproduced (namely, the clip (#1)) and the high-resolution data associated with the normal content are read out from the recording medium 200 (S222).

In more detail, the reproduction unit 115 reads out a stream file 239 (01000.m2te) regarding the high-resolution data in association with a clipinfo file 238 (01000.clpe). In addition, the reproduction unit 115 reads out the stream file 219 (01000.m2ts) regarding the normal content that is associated with the high-speed image sub-data by the clipinfo file 218 (01000.clpi).

Next, the first de-multiplex decompression unit 114 de-multiplexes and decompresses the normal content read out by the reproduction unit 115, and the second de-multiplex decompression unit 116 de-multiplexes and decompresses the high-resolution data read out by the reproduction unit 115 (S223). Here, the first de-multiplex decompression unit 114 and the second de-multiplex decompression unit 116 decompresses the normal content and the high-resolution data together, to reconstruct image data having the high resolution. In other words, the first de-multiplex decompression unit 114 and the second de-multiplex decompression unit 116 perform decompression processing based on layered coding according to the inter-layer prediction shown in FIG. 11. This means that the second de-multiplex decompression unit 116 de-multiplexes and decompresses the high-resolution data, using image data de-multiplexed and decompressed by the first de-multiplex decompression unit 114. In more detail, the second de-multiplex decompression unit 116 performs the decompression processing using (i) the inter-layer prediction reference image generated by the first de-multiplex decompression unit 114 and (ii) an decompression processing parameter used in the first de-multiplex decompression unit 114. Thereby, the reconstructed image signals have a resolution of 4096×2160 pixels or 3840×2160 pixels which is higher than a resolution of the conventional standard.

The image signal processing unit 113 performs image signal processing for display, such as noise cancellation and image quality adjustment to address compression distortion occurred in the image compression processing, on the reconstructed high-resolution image signals in order to generate high-resolution image. The display unit 112 displays the high-resolution image generated by the image signal processing unit 113 on a monitor or the like (S225).

As described above, at the high-resolution reproduction mode, the image recording/reproducing device 100 according to the second embodiment reads out (i) a normal content that is image data having the normal resolution in conformity to the conventional standard, from the BDMV main folder 210, and (ii) high-resolution data from the HIGHRESO main folder 230. Using the readout normal content and the readout high-resolution data, the image recording/reproducing device 100 reconstructs and reproduces high-resolution image.

On the other hand, if there is no clipinfo file 238 having the same file name as the file name of the clipinfo file 218 designated by the playlist file 217 (in other words, the image to be reproduced is normal captured image and high-resolution data associated with the normal captured image is not recorded) (No at S221), then the image recording/reproducing device 100 performs the same processing as the processing at the normal reproduction mode (S211 to S214). It should be noted that, when the recording medium 200 does not have such associated high-resolution data (No at S211), then the control unit 110 may display detail of the error or the like to the user and complete the reproduction processing.

Here, the above-described processing performed by the reproduction unit 115, the first de-multiplex decompression unit 114, the second de-multiplex decompression unit 116, and the image signal processing unit 113 are controlled by the control unit 110.

Thus, the image recording/reproducing device 100 according to the second embodiment of the present invention can record to the recording medium 200 and reproduce high-resolution image having a resolution higher than a resolution of a conventional standard.

In addition, when the recording medium 200 recorded by the image recording/reproducing device 100 according to the second embodiment is inserted to image reproducing devices in conformity to conventional standards which do not support reproduction of high-resolution image, the image reproducing devices can reproduce image having a resolution of 1920×1080 pixels in conformity to the conventional standard. That is, the image recording/reproducing device 100 can ensure compatibility with image reproducing devices having conventional standards.

In addition, the image recording/reproducing device 100 according to the second embodiment generates the playlist file 217 only in the BDMV main folder 210. Here, the playlist file 217 has a format in conformity to a conventional standard. Thereby, playlist editing can be performed by image reproducing devices in conformity to conventional standards that do not support reproduction of high-resolution image. Furthermore, even if on a recording medium a playlist is edited by such an image reproducing device in conformity to the conventional standard and the recording medium is inserted to the image recording/reproducing device 100 to be reproduced, it is possible to reproduce the high-resolution data by the procedure according to the edited playlist.

Furthermore, the image recording/reproducing device 100 according to the second embodiment records both of image data in conformity to a conventional standard and high-resolution data to a single file system in the recording medium 200. Therefore, data management is easy. That is, the image recording/reproducing device 100 according to the second embodiment can record high-resolution image to be easily managed.

Still further, the image recording/reproducing device 100 according to the second embodiment generates a folder structure of the HIGHRESO main folder 230 in association with a folder structure of the BDMV main folder 210. Thereby, a relationship between a normal content and an associated high-resolution data can be easily traced. Still further, processing for designating the stream files 219 and 239 using the playlist files 217 and 237 via the clipinfo files 218 and 238 to reproduce the designated stream files 219 and 239, respectively, can be shared between the processing for a normal content and the processing for high-resolution data. Thereby, implementation of the control unit 110 can be simplified.

Still further, if the HIGHRESO main folder 230 has the same backup folder 236 as that in the BDMV main folder 210, the file operation procedure for operating the backup folders during editing processing can be shared between the processing for a normal content and the processing for high-resolution data.

Although the image recording/reproducing device 100 according to the second embodiment of the present invention has been described as above, the present invention is not limited to the above.

It should be noted that it has been described in the above explanation that a single main folder regarding normal contents is associated with a single main folder regarding high-resolution data, but the high-resolution data may be divided into plural pieces which are recorded in respective different main folders.

It should also be noted that it has been described in the above explanation that image in conformity to a conventional standard has the resolution of 1920×1080 pixels, but image in conformity to a conventional standard may have any other resolution except the resolution of 1920×1080 pixels. For example, image in conformity to a conventional standard may have a resolution of 1440×1080 pixels.

It should also be noted that it has been described in the above explanation that high-resolution image has the resolution of 4096×2160 pixels or 3840×2160 pixels, but an image size of high-resolution image is not limited to the above and may be any other resolution higher than a resolution of a conventional standard.

It should also be noted that it has been described in the above explanation that in FIG. 14 the image recording/reproducing device 100 determines whether or not a reproduction mode is the high-resolution reproduction mode (S220) and then determines whether or not the high-resolution data exists (S221), but it is also possible that the image recording/reproducing device 100 firstly determines whether or not the high-resolution data exists (S221) and then determines whether or not a reproduction mode is the high-resolution production mode (S220). Furthermore, the image recording/reproducing device 100 may perform the determination as to whether or not a reproduction mode is the high-resolution reproduction mode (S220) per a predetermined time period.

It should also be noted that the folder structure shown in FIG. 13 is used in the above explanation, but the present invention is not limited to the above as far as (i) image for compatibility with a conventional standard and (i) high-resolution image are stored in respective different folders. In other words, the present invention is not limited as far as the playlist file 217, the clipinfo file 218, and the stream file 219 are recorded in the BDMV main folder 210 or in folders below the BDMV main folder 210 in a hierarchical structure. In addition, the clipinfo file 238 and the stream file 239 are recorded in the HIGHRESO main folder 230 or in folders below the HIGHRESO main folder 230 in a hierarchical structure.

It should also be noted that substance of the information included in each of the playlist file 217, the clipinfo file 218, and the stream file 219 is not necessarily stored in the BDMV main folder 210. It is also possible that only information for specifying the substance of the information included in each of the playlist file 217, the clipinfo file 218, and the stream file 219 is stored in the BDMV main folder 210. In other words, the present invention is not limited as far as the playlist file 217, the clipinfo file 218, and the stream file 219 are recorded in association with the BDMV main folder 210.

Likewise, substance of the information included in each of the clipinfo file 238 and the stream file 239 are not necessarily stored in the HIGHRESO main folder 230. It is also possible that only information for specifying the substance of the information included in each of the clipinfo file 238 and the stream file 239 is stored in the HIGHRESO main folder 230. In other words, the present invention is not limited as far as the clipinfo file 238 and the stream file 239 are recorded in association with the HIGHRESO main folder 230.

It should also be noted that it has been described that the clipinfo files 218 and 238 have the same file names, but the file names may be anything as far as the relationship between the files can be specified. For example, a part of each of the file names may be the same.

It should also be note that it has been described in the above explanation that the second compression multiplex unit 107 performs layered coding on high-resolution image signals using the information provided from the first compression multiplex unit 105, but may compress and multiplex the high-resolution image signals independently. Likewise, the second de-multiplex decompression unit 116 may compress and multiplex the high-resolution data independently.

It should also be note that it has been described in the first and second embodiments that the image recording/reproducing device 100 has both of a recording function of recording captured image data to the recording medium 200 and a reproduction function of reproducing the image data recorded on the recording medium 200, but the present invention may be implemented as an image recording device having only the recording function of the image recording/reproducing device 100 or an image reproducing device having only the reproduction function of the image recording/reproducing device 100.

It should also be note that the image recording/reproducing device 100 according to the present invention may further include a Central Processing Unit (CPU), a Large Scale Integrated Circuit (LSI), a Random Access Memory (RAM), a Read Only Memory (ROM), a Hard Disk Drive (HDD), a network interface, and the like. The image recording/reproducing device 100 may still further include a drive device that can read from and write to a portable recording medium, such as a DVD-RAM, a BD, or a Secure Digital (SD) card.

It should also be note that the image recording/reproducing device 100 may be implemented as a system embedded in a digital video camera, a digital camera, a digital recorder, a digital television set, a game machine, an Internet Protocol (IP) telephone, a portable telephone, or the like.

It is also possible that a program for controlling the image recording/reproducing device 100 (hereinafter, referred to as a “recording/reproducing program”) is installed in a HDD, a ROM, or the like and executed to achieve a part or all of the functions of the image recording/reproducing device 100.

Here, the recording/reproducing program may be recorded to a computer-readable recording medium that is readable for a hardware system such as a computer system or an embedded system. It is also possible that the recording/reproducing program is read from the recording medium to another hardware system and then executed. Thereby, each function of the image recording/reproducing device 100 can be implemented in the hardware system. Here, examples of the computer-readable recording medium are an optical recording medium such as a CD-ROM, a magnetic recording medium such as a hard disk, a magnetooptical recording medium such as a MO, and a semiconductor memory such as a memory card.

Further, the recording/reproducing program may be held in a hardware system connected to a network such as the Internet or a local area network. Furthermore, the recording/reproducing program may be downloaded from a network to a hardware system and then executed. Thereby, each function of the image recording/reproducing device 100 can be implemented in the hardware system. Here, examples of the network are a terrestrial broadcasting network, a satellite broadcasting network, a Power Line Communication (PLC), a mobile telephone network, a wire communication network such as IEEE802.3, and a wireless communication network such as IEEE802.11.

It should be noted that a part or all of the functions of the image recording/reproducing device 100 may be implemented as a recording/reproducing circuit (hardware) embedded in the image recording/reproducing device 100.

It should be noted that the recording/reproducing circuit may be formed in at least one of a semi custom LSI such as a full custom LSI or an Application Specific Integrated Circuit (ASIC), a programmable logic device, and a dynamic reconfigurable device in which a circuit configuration is dynamically rewritable. Here, examples of the programmable logic device are a Field Programmable Gate Array (FRGA) and a Complex Programmable Logic Device (CPLD).

Moreover, design data for forming each function of the image recording/reproducing device 100 in the recording/reproducing circuit may be a program described in a hardware description language (hereinafter, referred to as a “HDL program”). The design data may be a netlist at a gate level obtained by performing logic synthesis on the HDL program. The design data may be macro-cell information in which the netlist at a gate level is added with arrangement information, process conditions, and the like. The design data may be mask data defining a size, timing, and the like. Here, examples of the hardware description language are a Very high speed integrated circuit Hardware Description Language (VHDL), a Verilog-HDL, and a System C.

It is also possible that the design data is recorded on a computer-readable recording medium that is readable for a hardware system such as a computer system or an embedded system. The recording/reproducing program may be read from the recording medium to another hardware system and then executed. Then, the design data read from the recording medium to another hardware system may be downloaded to a programmable logic device via a download cable.

The design data may be held in a hardware system connected to a network such as the Internet or a local area network. Furthermore, the design data may be downloaded from a network to another hardware system and then executed. Then, the design data provided to another hardware system via a network may be downloaded to a programmable logic device via a download cable.

Or, the design data may be recorded on a serial ROM so that the design data can be transmitted to a FPGA when applying current. The design data recorded on the serial ROM may be downloaded directly to the FPGA when applying current.

Or, the design data may be generated by a microprocessor and downloaded to a FPGA when applying current.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be used as an image recording device, an image reproducing device, and a recording medium. More specifically, the present invention can be used as an image recording/reproducing device, such as a digital video camera, a digital camera, a digital recorder, a digital television set, a game machine, an IP telephone, or a portable telephone, which records and reproduces high-speed captured image or high-resolution image. Or, the present invention can be used as a recording medium in which the high-speed captured image or the high-resolution image is recorded by the image recording/reproducing device.

What is claimed is:

1. An image recording device that captures a second captured image and records the second captured image to a recording medium, the second captured image being captured according to a second method to have a accuracy higher than an accuracy of a first captured image captured according to a first method, and the recording medium being initialized to have a file system and being removable from said image recording device, said image recording device comprising:
an image signal processing unit configured to generate signals of the second captured image according to the second method from electrical signals converted from incident light signals by an imaging element;
a first compression unit configured to generate first compressed image data by compressing first image information that is image information included in the signals of the second captured image and that is equivalent to the first captured image;
a second compression unit configured to generate second compressed image data by compressing second image information that is image information included in the signals of the second captured image except at least a part of the image information included in the first image information; and
a recording unit configured to record the first compressed image data and the second compressed image data to the recording medium,
wherein said recording unit is configured to (i) create a first folder and a second folder in the file system, (ii-1) record the first compressed image data and a first playlist in association with the first folder, and (ii-2) record the second compressed image data in association with the second folder, the first playlist specifying a procedure for reproducing the first compressed image data,
wherein said recording unit is further configured to record the first compressed image data and the second compressed image data to the recording medium, so that a part of the first compressed image data and a part of the second compressed image data are recorded in association with each other, the part of the first compressed image data and the part of the second compressed image data being generated from a part of the second captured image which is captured during a same time period of a first time unit, and
during one unit of the first time unit, (i) one frame according to the first method and (ii) at least one frame according to the second method are included in the part of the second captured image.

2. The image recording device according to claim 1,
wherein the first captured image has a first frame rate,
the second captured image has a second frame rate higher than the first frame rate,
said first compression unit is configured to generate the first compressed image data by compressing frames that are included in the signals of the second captured image and that are equivalent to image having the first frame rate, and
said second compression unit is configured to generate the second compressed image data by compressing the other frames included in the signals of the second captured image except the frames equivalent to image having the first frame rate.

3. The image recording device according to claim 2, further comprising
a mode switching unit configured to switch between a first capturing mode and a second capturing mode, the first capturing mode being used for capturing the first captured image and recording the first captured image to the recording medium, and the second capturing mode being used for capturing the second captured image and recording the second captured image to the recording medium,
wherein at the first capturing mode,
said image signal processing unit is configured to generate signals of the first captured image having the first frame rate from the electrical signals converted by the imaging element,
said first compression unit is configured to generate third compressed image data by compressing the signals of the first captured image, and
said recording unit is configured to record the third compressed image data in association with the first folder,
wherein said recording unit is configured to record the first compressed image data generated at the second capturing mode and the third compressed image data generated at the first capturing mode to respective different files.

4. The image recording device according to claim 2,
wherein said recording unit is configured to assign a file name to (i) a file in which the first compressed image data is recorded, and a file name to (ii) a file in which the second compressed image data is recorded, in order to specify a one-to-one relationship between (i) the file in which the first compressed image data is recorded and (ii) the file in which the second compressed image data is recorded.

5. The image recording device according to claim 2,
wherein, when the part of the first compressed image data which is generated from a first frame to a second frame according to the first frame rate in the second captured image is recorded to the recording medium, said recording unit is configured to record, as the part of the second compressed image data associated with the part of the first compressed image data, the part of the second compressed image data which is generated from frames according to the second frame rate in the second captured image ranging from a frame immediately after the first frame to a frame immediately prior to a third frame, and
the third frame is a frame subsequent to the second frame according to the first frame rate.

6. The image recording device according to claim 2,
wherein said recording unit is configured not to record a second playlist in association with the second folder, the second playlist specifying a procedure for reproducing the second compressed image data.

7. The image recording device according to claim 1,
wherein the first captured image has a first resolution, and
the second captured image has a second resolution higher than the first resolution,
said image recording device further comprising
a first-resolution conversion unit configured to convert the second resolution of the signals of the second captured image so as to generate signals of the first captured image having the first resolution as the first image information,
wherein said first compression unit is configured to generate the first compressed image data including first compression information, by compressing the signals of the first captured image using the first compression information, and
said second compression unit is configured to generate the second compressed image data by compressing the signals of the second captured image using the first compression information.

8. The image recording device according to claim 7, further comprising
a mode switching unit configured to switch between a first capturing mode and a second capturing mode, the first capturing mode being used for capturing the first captured image and recording the first captured image to the recording medium, and the second capturing mode being used for capturing the second captured image and recording the second captured image to the recording medium,
wherein at the first capturing mode,
said image signal processing unit is configured to generate signals of third captured image having the first resolution from the electrical signals converted by the imaging element,
said first compression unit is configured to generate third compressed image data by compressing the signals of the third captured image, and
said recording unit is configured to record the third compressed image data in association with the first folder,
wherein said recording unit is configured to record the first compressed image data generated at the second capturing mode and the third compressed image data generated at the first capturing mode to respective different files.

9. The image recording device according to claim 7,
wherein said recording unit is configured to assign a file name to (i) a file in which the first compressed image data is recorded, and a file name to (ii) a file in which the second compressed image data is recorded, in order to specify a one-to-one relationship between (i) the file in which the first compressed image data is recorded and (ii) the file in which the second compressed image data is recorded.

10. The image recording device according to claim 7,
wherein said recording unit is configured not to record a second playlist in association with the second folder, the second playlist specifying a procedure for reproducing the second compressed image data.

11. An image reproducing device that reproduces a second captured image recorded in a recording medium, the second captured image being captured according to a second method to have an accuracy higher than an accuracy of a first captured image captured according to a first method, and the recording medium being initialized to have a file system and being removable from said image reproducing device, said image reproducing device comprising:
a readout unit configured to read out first compressed image data and second compressed image data, the first compressed image data being recorded in the recording medium in association with a first folder in the file system, and the second compressed image data being recorded in the recording medium in association with a second folder in the file system;
a first decompression unit configured to generate first image data by decompressing the first compressed image data;
a second decompression unit configured to generate second image data by decompressing the second compressed image data;
an image signal processing unit configured to generate signals of the second captured image captured according to the second method from the first image data and the second image data;
a reproducing unit configured to reproduce the signals of the second captured image; and
a reproduction control unit configured to control reproduction of the first compressed image data and the second compressed image data associated with the first compressed image data by a reproduction procedure included in a playlist recorded in association with the first folder,
wherein the first compressed image data is generated by compressing first image information that is image information included in the second captured image and that is equivalent to the first captured image, and
the second compressed image data is generated by compressing second image information that is image information included in the second captured image except at least a part of the image information included in the first image information.

12. The image reproducing device according to claim 11,
wherein the first captured image has a first frame rate,
the second captured image has a second frame rate higher than the first frame rate,
the first compressed image data is generated by compressing frames that are included in the second captured image and that are equivalent to image having the first frame rate,
the second compressed image data is generated by compressing the other frames included in the second captured image except the frames equivalent to image having the first frame rate, and
said image signal processing unit is configured to generate the signals of the second captured image by synthesizing the first image data with the second image data, when the second compressed image data is recorded on the recording medium.

13. The image reproducing device according to claim 12,
wherein, when a part of the first compressed image data which is generated from a first frame to a second frame according to the first frame rate in the second captured image is reproduced, said reproduction control unit is configured to perform the control to reproduce a part of the second compressed image data which is generated from frames according to the second frame rate in the second captured image ranging from a frame immediately after the first frame to a frame immediately prior to a third frame, and
the third frame is a frame subsequent to the second frame according to the first frame rate.

14. The image reproducing device according to claim 11,
wherein the first captured image has a first resolution,
the second captured image has a second resolution higher than the first resolution,
said first decompression unit is configured to generate the first image data by decompressing the first compressed image data using first compression information included in the first compressed image data, and
said second decompression unit is configured to generate the second image data by decompressing the second compressed image data using the first compression information.

15. A recording medium on which a second captured image is recorded, the second captured image being captured according to a second method to have an accuracy higher than an accuracy of a first captured image captured according to a first method, and said recording medium being initialized to have a file system and being removable from an image recording device and an image reproducing device, said recording medium comprising:
a first folder and a second folder in the file system;
first compressed image data which is recorded in association with the first folder, and is generated by compressing first image information that is image information included in the second captured image and that is equivalent to the first captured image;
first playlist which is recorded in association with the first folder, and specifies a procedure for reproducing the first compressed image data; and
second compressed image data recorded in association with the second folder, the second compressed image data being generated by compressing second image information that is image information included in the second captured image except at least a part of the image information included in the first image information,
wherein a part of the first compressed image data and a part of the second compressed image data are recorded in association with each other on said recording medium, the part of the first compressed image data and the part of the second compressed image data being generated from a part of the second captured image which is captured during a same time period of a first time unit, and
during one unit of the first time unit, (i) one frame according to the first method and (ii) at least one frame according to the second method are included in the part of the second captured image.

16. The recording medium according to claim 15,
wherein the first captured image has a first frame rate,
the second captured image has a second frame rate higher than the first frame rate,
the first compressed image data is generated by compressing frames that are included in the second captured image and that are equivalent to image having the first frame rate, and
the second compressed image data is generated by compressing the other frames included in the second captured image except the frames equivalent to image having the first frame rate.

17. The recording medium according to claim 16,
wherein a second playlist is not recorded in association with the second folder, the second playlist specifying a procedure for reproducing the second compressed image data.

18. The recording medium according to claim 15,
wherein the first captured image has a first resolution,
the second captured image has a second resolution higher than the first resolution,
the first compressed image data is generated by compressing the first captured image and includes first compression information used in the compression of the first captured image, and
the second compressed image data is generated by compressing the second captured image using the first compression information.

19. An image recording method used in an image recording device that captures a second captured image and records the second captured image to a recording medium, the second captured image being a high-speed captured image and being captured according to a second method to have an accuracy higher than an accuracy of a first captured image captured according to a first method, and the recording medium being initialized to have a file system and being removable from the image recording device, said image recording method comprising:
generating signals of the second captured image according to the second method from electrical signals converted from incident light signals by an imaging element;
generating first compressed image data by compressing first image information that is image information included in the signals of the second captured image and that is equivalent to the first captured image;
generating second compressed image data by compressing second image information that is image information included in the signals of the second captured image except at least a part of the image information included in the first image information; and
recording the first compressed image data and the second compressed image data to the recording medium,
wherein said recording includes: (i) creating a first folder and a second folder in the file system; (ii-1) recording the first compressed image data and a first playlist in association with the first folder; and (ii-2) recording the second compressed image data in association with the second folder, the first playlist specifying a procedure for reproducing the first compressed image data,
wherein in said recording, a part of the first compressed image data and a part of the second compressed image data are recorded in association with each other, the part of the first compressed image data and the part of the second compressed image data being generated from a part of the second captured image which is captured during a same time period of a first time unit, and
during one unit of the first time unit, (i) one frame according to the first method and (ii) at least one frame according to the second method are included in the part of the second captured image.

20. A program of an image recording method used in an image recording device that captures a second captured image and records the second captured image to a recording medium, the second captured image being a high-speed captured image and being captured according to a second method to have an accuracy higher than an accuracy of a first captured image captured according to a first method, and the recording medium being initialized to have a file system and being removable from the image recording device, said program being recorded on a computer-readable recording medium and causing a computer to execute:
generating signals of the second captured image according to the second method from electrical signals converted from incident light signals by an imaging element;
generating first compressed image data by compressing first image information that is image information included in the signals of the second captured image and that is equivalent to the first captured image;
generating second compressed image data by compressing second image information that is image information included in the signals of the second captured image except at least a part of the image information included in the first image information; and
recording the first compressed image data and the second compressed image data to the recording medium,
wherein said recording includes: (i) creating a first folder and a second folder in the file system; (ii-1) recording the first compressed image data and a first playlist in association with the first folder; and (ii-2) recording the second compressed image data in association with the second folder, the first playlist specifying a procedure for reproducing the first compressed image data,
wherein in said recording, a part of the first compressed image data and a part of the second compressed image data are recorded in association with each other, the part of the first compressed image data and the part of the second compressed image data being generated from a part of the second captured image which is captured during a same time period of a first time unit, and
during one unit of the first time unit, (i) one frame according to the first method and (ii) at least one frame according to the second method are included in the part of the second captured image.
